(19) United States
(12) Patent Application Publication
(10) Pub. No.: US 2019/0113985 A1
(43) Pub. Date: Apr. 18, 2019

(54) INPUT DEVICE AND INPUT SYSTEM

(71) Applicant: Panasonic Intellectual Property Management Co., Ltd., Osaka (JP)

(72) Inventors: MASAKI SAWADA, Osaka (JP); MASAHISA NIWA, Osaka (JP); TAKEFUMI INOUE, Nara (JP); HIDEKI TAKAHASHI, Osaka (JP); TOSHIHIRO KONISHI, Hyogo (JP)

(73) Assignee: Panasonic Intellectual Property Management Co., Ltd., Osaka (JP)

(21) Appl. No.: 15/779,600

(22) PCT Filed: Jan. 10, 2017
(86) PCT No.: PCT/JP2017/000377

§ 371 Date: May 29, 2018

(30) Foreign Application Priority Data
Jan. 27, 2016 (JP) 2016-013343

(51) Int. Cl. G06F 3/0362; G06F 3/0338; G06F 3/03; G05F 1/67; G06F 3/041

(52) U.S. Cl. CPC G06F 3/0362; G06F 3/0338; G06F 3/0412; G05F 1/67; G06F 3/0304

(57) ABSTRACT

An input device includes a housing, an operation unit, an attaching portion, a photovoltaic unit, and a signal processor. The operation unit is movable relative to the housing. The attaching portion is used for attaching the housing. The photovoltaic unit is held by the housing, and generates electric power with use of light incident from a side where the attaching portion is disposed in the housing. The signal processor operates by receiving the electric power generated by the photovoltaic unit, and transmits detection information generated in response to movement of the operation unit via wireless communication.

### TECHNICAL FIELD

The present invention relates generally to an input device and an input system, and in particular, to an input device and an input system that output detection information in response to movement of an operation unit.

### BACKGROUND ART

Conventionally, as an input device accompanied by movement of an operation unit, an input device having a rotary operation unit has been known, for example (see PTL 1, for example).

An input system described in PTL 1 includes a device body having a display panel, and an input device having a rotary operation unit. The display panel is provided with a touch panel. The operation unit is provided with a terminal that is in contact with the touch panel and moves on the touch panel along with a rotary operation. The input system detects movement of the terminal on the touch panel, and operates the device body. Accordingly, the operation unit can operate the device body without an electric wire or the like connecting the operation unit with the device body.

PTL 1 describes that the terminal moves along with rotary operation of the operation unit, a quantity of movement is detected in the touch panel as a quantity of operation, and a volume control process of the device body corresponding to the quantity of operation is performed.

### CITATION LIST

### Patent Literature

PTL 1: Unexamined Japanese Patent Publication No. 2012-35782

### SUMMARY OF THE INVENTION

However, in the input system described above, the quantity of movement of the terminal provided to the operation unit is detected in the touch panel. Therefore, it is mere indirect operation of the touch panel. Accordingly, in the input system, if a touch panel is not provided to the display panel, the input system cannot detect operation of the operation unit. This means that it is indispensable to use a touch panel.

An object of the present invention is to provide an input device and an input system capable of detecting operation of an operation unit without using a touch panel.

An input device according to one aspect of the present invention includes a housing, an operation unit, an attaching portion, a photovoltaic unit, and signal processor. The operation unit is movable relative to the housing. The attaching portion is used for attaching the housing. The photovoltaic unit is held by the housing, and generates electric power with use of light incident from a side where the attaching portion is disposed in the housing. The signal processor operates by receiving the electric power generated by the photovoltaic unit, and transmits detection information generated in response to movement of the operation unit via wireless communication.

In the input device according to one aspect of the present invention, the attaching portion is a sucker.

In the input device according to one aspect of the present invention, the housing includes a transmission part that transmits the light incident from a side where the attaching portion is disposed in the housing.

In the input device according to one aspect of the present invention, when a predetermined change occurs in the electric power generated by the photovoltaic unit, the signal processor transmits notification information via wireless communication.

The input device according to one aspect of the present invention further includes a regulation member that changes a quantity of light incident on the photovoltaic unit in conjunction with the movement of the operation unit. The signal processor detects movement of the operation unit based on a change in the electric power generated by the photovoltaic unit, and transmits detection information generated in response to a detection result of the movement of the operation unit via wireless communication.

In the input device according to one aspect of the present invention, the operation unit is disposed rotatably in either direction relative to the housing. The regulation member is formed to change the quantity of light incident on the photovoltaic unit differently, depending on the case where the operation unit is rotated in one direction and the case where the operation unit is rotated in an opposite direction.

In the input device according to one aspect of the present invention, the operation unit is disposed rotatably in either direction relative to the housing. The photovoltaic unit includes a first photovoltaic unit and a second photovoltaic unit. The regulation member gives a different phase to the quantity of light incident on the first photovoltaic unit and to the quantity of light incident on the second photovoltaic unit, when the operation unit is rotated.

The input device according to one aspect of the present invention further includes a light receiving element and a light shielding unit. The light receiving element is disposed at a position where the light receiving element can receive light incident from the side where the attaching portion is disposed in the housing. The light shielding unit changes a quantity of light incident on the light receiving element in conjunction with the movement of the operation unit. The signal processor detects the movement of the operation unit based on a change in an output of the light receiving element, and transmits detection information generated in response to a detection result of the movement of the operation unit via wireless communication.

In the input device according to one aspect of the present invention, the operation unit is disposed rotatably in either direction relative to the housing. The light shielding unit is formed to change the quantity of light incident on the light receiving element differently, depending on a case where the operation unit is rotated in one direction and a case where the operation unit is rotated in an opposite direction.

In the input device according to one aspect of the present invention, the operation unit is disposed rotatably in either direction relative to the housing. The light receiving element includes a first light receiving element and a second light receiving element. The light shielding unit gives a different phase to a quantity of light incident on the first light receiving element and to a quantity of light incident on the second light receiving element, when the operation unit is rotated.

In the input device according to one aspect of the present invention, the housing includes a contact portion to be brought into contact with an attaching target portion in a state where the housing is attached to the attaching target portion via the attaching portion.

An input system according to one aspect of the present invention includes the input device described above and a display device. The display device includes a display unit having a display surface to which the attaching portion is attached, and a control circuit that controls display content to be displayed on the display unit and allows the display content to be displayed on the display unit.

In the input system according to one aspect of the present invention, in a reception waiting state in which reception of information transmitted from the input device via wireless communication is waited, the control circuit controls the display content so as to allow the attaching position of the input device on the display surface to emit light.

In the input system according to one aspect of the present invention, the operation unit includes a notification operation unit to be operated for notifying that the input device is in an attached state where the input device is attached to the display surface. The signal processor transmits, via wireless communication, start-up information for notifying the attached state when the notification operation unit is operated.

In the input system according to one aspect of the present invention, the control circuit allows a specific region in which a position of the specific region moves as time passes to be displayed on the display unit. Optical energy emitted from the specific region differs from optical energy emitted from a region other than the specific region on the display surface. The signal processor transmits notification information via wireless communication when a predetermined change occurs in the electric power generated by the photovoltaic unit. The control circuit estimates an attaching position of the input device on the display surface from a position of the specific region at a time when the control circuit receives the notification information in a state where the specific region is displayed on the display unit.

In the input system according to one aspect of the present invention, the input device further includes a light detection element disposed at a position where the light detection element is able to receive light incident from a side where the attaching portion is disposed in the housing. The control circuit allows a specific region in which a position of the specific region moves as time passes to be displayed on the display unit. Optical energy emitted from the specific region differs from optical energy emitted from a region other than the specific region on the display surface. The signal processor transmits notification information via wireless communication when a predetermined change occurs in an output of the light detection element. The control circuit estimates the attaching position of the input device on the display surface from a position of the specific region at a time when the control circuit receives the notification information in a state where the specific region is displayed on the display unit.

In the input system according to one aspect of the present invention, the specific region is in a band shape, and moves along a first direction on the display surface and a second direction on the display surface, the second direction crossing the first direction.

In the input system according to one aspect of the present invention, optical energy emitted from the specific region is smaller than optical energy emitted from a region other than the specific region on the display surface.

In the input system according to one aspect of the present invention, the control circuit controls the display content such that optical energy emitted from the attaching position of the input device on the display surface becomes a predetermined optical energy, according to a result of estimating the attaching position of the input device on the display surface.

In the input system according to one aspect of the present invention, the control circuit controls a position of the display content to be displayed around the attaching position of the input device on the display surface, according to a result of estimating the attaching position of the input device on the display surface.

According to the input device according to the present invention, the photovoltaic unit can generate electric power with use of light incident from a side where the attaching portion is disposed in the housing. Then, the signal processor operates by receiving the electric power generated by the photovoltaic unit. The signal processor transmits detection information generated in response to movement of the operation unit, via wireless communication. Accordingly, the input device can detect operation of the operation unit without using a touch panel.

According to the input system of the present invention, the photovoltaic unit can generate electric power with use of light of the display device incident from a side where the attaching portion is disposed in the housing. Then, the signal processor operates by receiving the electric power generated by the photovoltaic unit. The signal processor transmits detection information generated in response to movement of the operation unit, via wireless communication. Accordingly, the input system can detect operation of the operation unit without using a touch panel.

### BRIEF DESCRIPTION OF DRAWINGS

FIG. 1 is a perspective cross-sectional view of an input device according to a first exemplary embodiment of the present invention.

FIG. 2 is an exploded perspective view of the input device according to the first exemplary embodiment of the present invention.

FIG. 3 is a perspective view of an input system according to the first exemplary embodiment of the present invention.

FIG. 4A is a front view of the input device according to the first exemplary embodiment of the present invention.

FIG. 4B is a left side view of the input device according to the first exemplary embodiment of the present invention.

FIG. 5A is a cross-sectional view in a positioning state of the input device according to the first exemplary embodiment of the present invention.

FIG. 5B is a cross-sectional view in a temporarily fixed state of the input device according to the first exemplary embodiment of the present invention.

FIG. 5C is a cross-sectional view in a regularly fixed state of the input device according to the first exemplary embodiment of the present invention.

FIG. 6A is a top view of the input device according to the first exemplary embodiment of the present invention.

FIG. 6B is a cross-sectional view, taken along line 6B-6B in FIG. 1, of the input device according to the first exemplary embodiment of the present invention.

FIG. 6C is a cross-sectional view, taken along line 6C-6C in FIG. 1, of the input device according to the first exemplary embodiment of the present invention.

FIG. 7 is a block diagram of the input system according to the first exemplary embodiment of the present invention.

FIG. 8 is a flowchart for describing a position search operation of the input system according to the first exemplary embodiment of the present invention.

FIG. 9A is an illustration of a specific region that moves along a front-rear direction displayed in the input system according to the first exemplary embodiment of the present invention.

FIG. 9B is an illustration of a specific region that moves along a left-right direction displayed in the input system according to the first exemplary embodiment of the present invention.

FIG. 9C is an illustration of input display content displayed in the input system according to the first exemplary embodiment of the present invention.

FIG. 10 is a flowchart for describing a normal operation of the input system according to the first exemplary embodiment of the present invention.

FIG. 11A is a perspective view of a lock mechanism in a regularly fixed state of an input device, seen from below, according to a second exemplary embodiment of the present invention.

FIG. 11B is a perspective view of the lock mechanism in a positioning state of the input device, seen from below, according to the second exemplary embodiment of the present invention.

FIG. 12 is a perspective cross-sectional view of an input device according to a third exemplary embodiment of the present invention.

FIG. 13 is an exploded perspective view of the input device according to the third exemplary embodiment of the present invention.

FIG. 14 is a bottom view illustrating part of the input device according to the third exemplary embodiment of the present invention.

FIG. 15 is a block diagram of an input system according to the third exemplary embodiment of the present invention.

### DESCRIPTION OF EMBODIMENTS

Hereinafter, an input device and an input system according to exemplary embodiments of the present invention will be described with reference to the drawings. It should be noted that the configuration described below is merely one example of the present invention, and the present invention is not limited to the following exemplary embodiments. Therefore, besides the following exemplary embodiments, various modifications are possible depending on design or the like without departing from the scope of the technical idea of the present invention.

### First Exemplary Embodiment

### (1) Outline

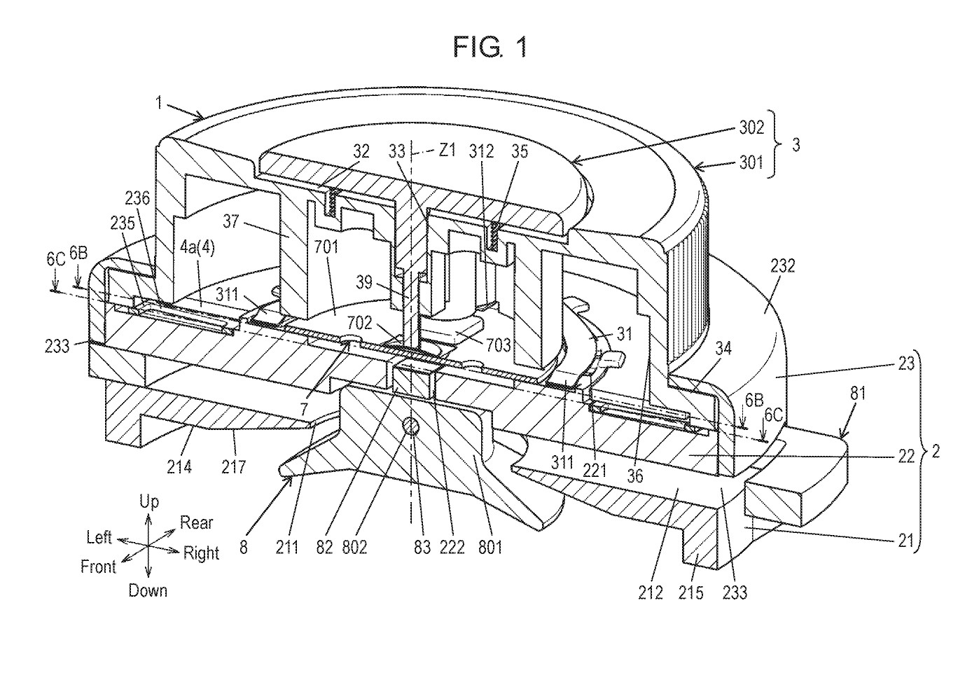

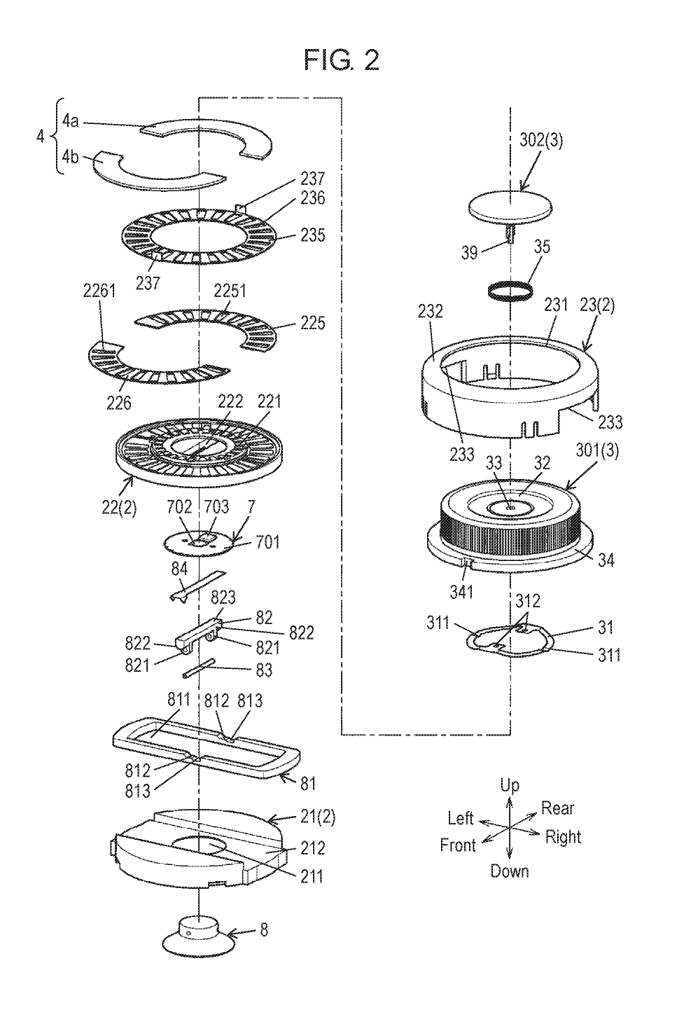

As illustrated in FIGS. 1 and 2, input device 1 according to a first exemplary embodiment includes housing 2, operation unit 3, attaching portion 8, photovoltaic unit 4, and signal processor 7.

Operation unit 3 is movable relative to housing 2. Attaching portion 8 is used for attaching housing 2. Photovoltaic unit 4 is held by housing 2, and generates electric power with use of light made incident from a side where attaching portion 8 is disposed in housing 2. Signal processor 7 operates by receiving electric power generated by photovoltaic unit 4, and transmits detection information generated in response to movement of operation unit 3 via wireless communication.

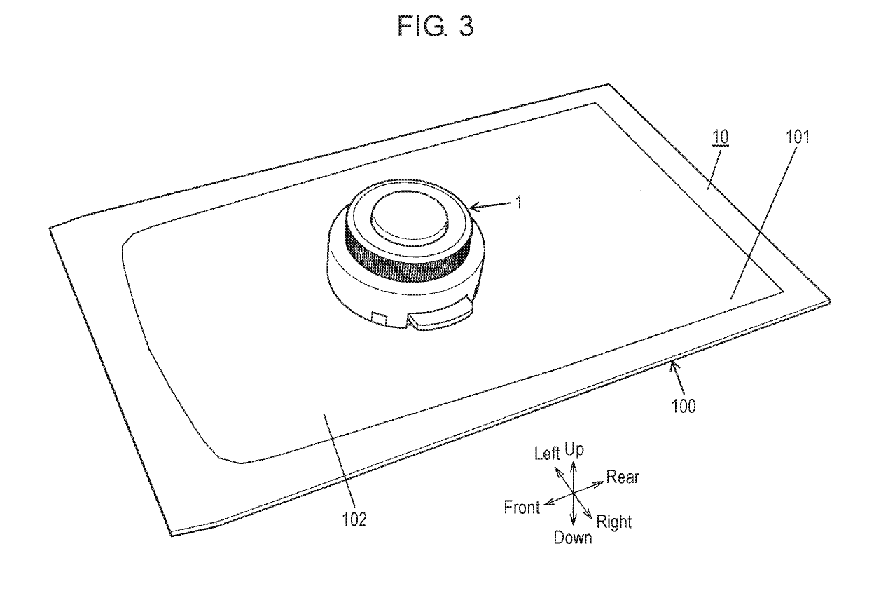

Input device 1 is used for operating an operation target device. The detection information generated by input device 1 is transmitted to an operation target device via wireless communication. This means that when operation unit 3 is operated in input device 1, detection information is transmitted from input device 1 to the operation target device. The operation target device is display device 100 (see FIG. 3), for example. Display device 100 may allow another device to perform an operation corresponding to detection information based on the detection information input from input device 1.

In input device 1 of the present exemplary embodiment, photovoltaic unit 4 generates electric power with use of light made incident from a side where attaching portion 8 is disposed in housing 2. In a state where housing 2 is attached to display device 100 via attaching portion 8, photovoltaic unit 4 generates electric power with use of light output from display device 100. Then, signal processor 7 operates by receiving the electric power generated by photovoltaic unit 4. Signal processor 7 transmits detection information generated in response to movement of operation unit 3, via wireless communication. Accordingly, a user can operate the operation target device by operating operation unit 3 without an electric wire or the like connecting input device 1 with the operation target device. Accordingly, input device 1 can detect operation of operation unit 3 by input device 1 itself without using a touch panel.

### (2) Detail

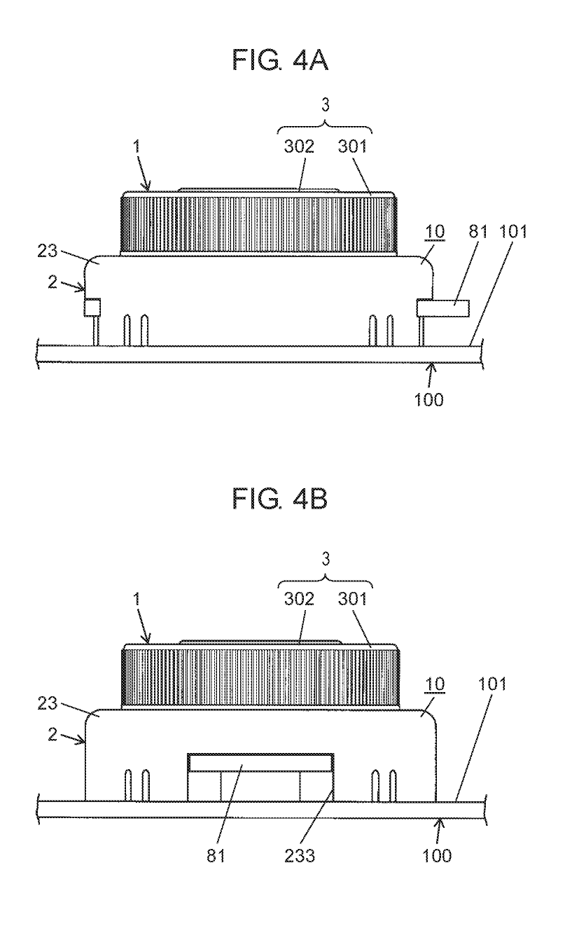

Input device 1 described below is used in a state of being attached to the operation target device, as illustrated in FIGS. 3 to 4B. The operation target device is display device 100. Input system 10 according to the first exemplary embodiment includes input device 1 and display device 100. Input device 1 is to be attached to attaching surface 101 of the operation target device. In the case where the operation target device is display device 100, attaching surface 101 is a display surface (display screen) of display device 100. When operation unit 3 of input device 1 is operated, detection information is transmitted from input device 1 to display device 100 via wireless communication. Accordingly, even though input device 1 is not connected with display device 100 by an electric wire or the like, input device 1 functions as an input interface of display device 100.

Display device 100 includes touch panel display 102. Therefore, display device 100 changes display content of touch panel display 102 or controls another device, for example, through a touching operation performed on touch panel display 102, basically. Further, when input operation by input device 1 is instructed by application software executed by display device 100, display device 100 displays input display content requesting a user to perform input operation by input device 1, on the display surface of touch panel display 102. The term “input display content” used herein means a description describing the control content when input device 1 is operated, operation guidance for input operation, an operation range of the operation unit 3 of input device 1, and the like.

When a user operates operation unit 3 while looking at the input display content displayed on the display surface of display device 100, detection information is transmitted from input device 1 to display device 100 via wireless communication. Display device 100 receives the detection information from input device 1, and controls another device or changes the display content displayed on the display surface of touch panel display 102, for example. As described above, display device 100 is operable by both touching operation performed on touch panel display 102 and operation performed on input device 1. When display device 100 includes touch panel display 102, attaching surface 101 of display device 100 is a display surface of touch panel display 102. The display provided to display device 100 is not limited to touch panel display 102. Display device 100 may be a device having a liquid crystal display only used for display, and a communication function. In that case, the display surface of the liquid crystal display serves as attaching surface 101. Further, a signal transmitted from input device 1 via wireless communication is received using the communication function of display device 100.

Hereinafter, unless otherwise mentioned, description will be given under assumption that in a state where input device 1 is attached to display device 100, a direction orthogonal to attaching surface 101 is an “up-down direction”, and an input device 1 side seen from attaching surface 101 is an upper side. Further, description will be given under assumption that a longitudinal direction of attaching surface 101 is a “front-rear direction”, and a left and right direction when input device 1 is seen from the front side (direction orthogonal to the up-down direction) is a “left-right direction”. That is, directions of up, down, left, right, front, and rear are defined as indicated by an “up” arrow, a “down” arrow, a “left” arrow, a “right” arrow, a “front” arrow, and a “rear” arrow in FIG. 1 or other drawings. However, it should be noted that these directions are not intended to specify the direction of use of input device 1. Further, the arrows indicating the respective directions in the drawings are merely illustrated for description, and they are unsubstantial.

### (2.1) Configuration

As illustrated in FIGS. 1 to 4B, input device 1 according to the present exemplary embodiment includes housing 2, operation unit 3, attaching portion 8, photovoltaic unit 4, and signal processor 7. Photovoltaic unit 4 includes A-phase solar battery 4a and B-phase solar battery 4b. A-phase solar battery 4a is an example of a first photovoltaic unit. B-phase solar battery 4b is an example of a second photovoltaic unit. Input device 1 further includes a slider 81.

Housing 2 is made of a synthetic resin, for example. Housing 2 has first case 21, second case 22, and third case 23. The shape of each of first case 21 and second case 22 is a disk shape that is flat in the up-down direction. First case 21 and second case 22 each are made of a material having a light transmitting property (for example, polycarbonate, acrylic resin, or the like). The shape of third case 23 is a cylindrical shape in which both faces in the up-down direction are opened. Second case 22 is fitted to first case 21 from the above. Third case 23 is fitted to second case 22 from the above. Thus, second case 22 is arranged in a space surrounded by first case 21 and third case 23. First case 21 and second case 22 are screw-fixed with a machine screw or the like, for example. Third case 23 may be linked to first case 21 by a screw. The shape of housing 2 configured as described above is a hollow flat columnar shape as a whole.

As illustrated in FIGS. 1 and 2, a center portion of first case 21 has a hole 211 penetrating first case 21 in the up-down direction. Hole 211 is a hole opening in a circular shape in the lower surface of housing 2. On the upper surface of first case 21, first groove 212 is formed over both ends of first case 21 in the left-right direction. First groove 212 is formed in such a manner that a center portion on the upper surface of first case 21 in the front-rear direction is recessed downward. In first groove 212, slider 81 is disposed. Therefore, in a state where second case 22 is placed on first case 21, movement of slider 81 in the up-down direction and the front-rear direction is restricted.

On the lower surface of first case 21, first recess 214 opened in a circular shape is formed. In a state where input device 1 is attached to display device 100, a space for receiving attaching portion 8 is formed in first recess 214. The bottom surface of first recess 214 is formed in a tapered shape such that first recess 214 becomes deeper toward hole 211. Protrusion 801 that is an upper portion of attaching portion 8 protrudes upward through the upper surface of first case 21 through hole 211. In this state, when protrusion 801 is linked to holding cam 82 by holding rod 83, attaching portion 8 is held by first case 21.

In a lower portion of first case 21, a surrounding wall 215 (contact portion) surrounding first recess 214 is provided. In a state where housing 2 is attached to attaching surface 101 (attaching target portion) of display device 100 via attaching portion 8, surrounding wall 215 is in contact with attaching surface 101. Thus, an attached state of housing 2 with respect to attaching surface 101 is stabilized, and a distance between photovoltaic unit 4 and attaching surface 101 (display surface) is kept constant. Therefore, a quantity of electric power generated by photovoltaic unit 4 is stabilized.

In first case 21, lens 217 that condenses light on photovoltaic unit 4 may be formed in a tapered portion around hole 211. When lens 217 that is a light condensing unit is formed on the lower side (display device 100 side) of photovoltaic unit 4, it is possible to increase light made incident on photovoltaic unit 4 to thereby increase the quantity of electric power generated by photovoltaic unit 4. As a light condensing unit, a light guide unit that guides light made incident from display device 100 to photovoltaic unit 4 may be formed instead of lens 217. Thus, the quantity of electric power generated by photovoltaic unit 4 can be increased.

On the upper surface of second case 22, two light shielding plates 225, 226 made of a material having light shielding property (metal, for example) are provided. In an upper portion of second case 22, light shielding plate 235 made of a material having a light shielding property (metal, for example) is disposed above two light shielding plates 225, 226. Further, in the upper portion of second case 22, A-phase solar battery 4a and B-phase solar battery 4b, constituting photovoltaic unit 4, are disposed above light shielding plate 235. A-phase solar battery 4a and B-phase solar battery 4b are fixed to second case 22. A-phase solar battery 4a is positioned on the upper side of light shielding plate 225, and B-phase solar battery 4b is positioned on the upper side of light shielding plate 226. Here, a space between A-phase solar battery 4a and light shielding plate 225, and a space between B-phase solar battery 4b and light shielding plate 226 are larger than the thickness of light shielding plate 235. Accordingly, light shielding plate 235 is rotatable relative to second case 22. With respect to A-phase solar battery 4a and B-phase solar battery 4b, second case 22 and first case 21 exist on the light incident side. However, since first case 21 and second case 22 have a light transmitting property, light passing through first case 21 and second case 22 is made incident on photovoltaic unit 4. In this example, first case 21 and second case 22 serve as a transmission part that transmits light, provided on the light incident side with respect to photovoltaic unit 4.

Further, on the upper surface of second case 22, a plurality of projections 221, each projecting upward, are provided on an inner side of a portion where light shielding plates 225, 226 are disposed. Respective projections 221 are provided to be aligned in a circumferential direction at certain intervals. On the upper surface of second case 22, the inner side of the portion where projections 221 are provided has second groove 222 penetrating second case 22 in the up-down direction. On the upper surface of second case 22, printed board 701 is disposed on the inner side of the portion where projections 221 are provided. Printed board 701 is a disk-shaped substrate. On printed board 701, electronic parts constituting signal processor 7 are mounted. A circuit of signal processor 7 is electrically connected with A-phase solar battery 4a and B-phase solar battery 4b. Printed board 701 is disposed on the upper surface of second case 22 so as to cover second groove 222, and is fixed to second case 22 with use of a screw, for example.

Around opening 231 on the upper surface side of third case 23, extending portion 232 extending toward the inside of third case 23 is formed. Opening 231 is a hole opening in a circular shape in the upper surface of housing 2. On the lower surface of third case 23, second recess 233 is formed. Second recess 233 is formed in such a manner that a center portion in the front-rear direction on the lower surface of third case 23 is recessed upward. Second recess 233 forms a slide hole opened to both sides in the left-right direction of housing 2, together with first groove 212. In the slide hole, slider 81 is disposed.

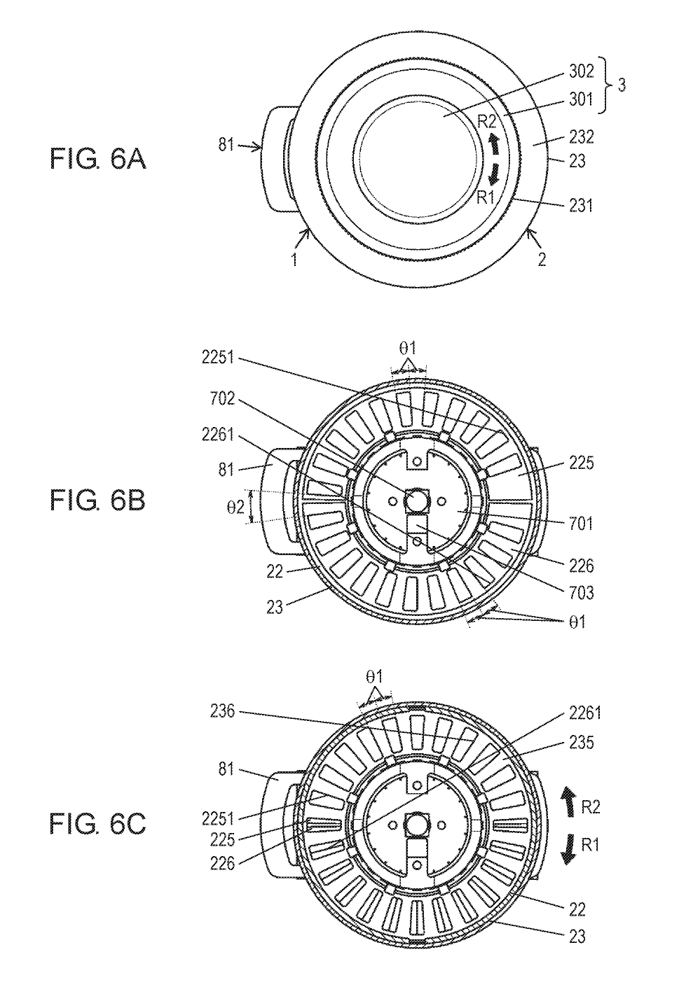

Each of light shielding plates 225, 226 has a shape like a ring-shaped plate member being divided into a half, as illustrated in FIG. 6B. Light shielding plates 225, 226 are disposed on the upper surface of second case 22 so as to form a ring by two light shielding plates 225, 226. Light shielding plates 225, 226 respectively have a plurality of through holes 2251, 2261. Each of through holes 2251, 2261 is formed to have the same shape and dimension, and is formed to have a rectangular shape in which a direction (radial direction) orthogonal to the circumferential direction of light shielding plates 225, 226 is a longitudinal direction. Respective through holes 2251 are provided at certain intervals in a circumferential direction of light shielding plate 225. An angle (inner angle) defined by two long sides of each through hole 2251 is θ1. An angle defined by long sides of two adjacent through holes 2251 is also θ1. This means that each through hole 2251 is provided in the circumferential direction by a certain angle (2×θ1). Similarly, an angle (inner angle) defined by two long sides of each through hole 2261 is θ1. An angle defined by long sides of two adjacent through holes 2261 is also θ1. This means that each through hole 2261 is provided in the circumferential direction by a certain angle (2×θ1). Then, in a state where light shielding plates 225, 226 are disposed on second case 22, through hole 2251 of light shielding plate 225 and through hole 2261 of light shielding plate 226 located at the closest positions to each other are distant by an angle θ2 that is 1.5 times the angle θ1 in the circumferential direction.

Each of A-phase solar battery 4a and B-phase solar battery 4b is formed to have a shape like a ring-shaped plate member being divided in a half. A-phase solar battery 4a and B-phase solar battery 4b are formed to have the same shape and dimensions as those of light shielding plate 225 and light shielding plate 226, respectively. A-phase solar battery 4a and B-phase solar battery 4b are attached to the upper side of second case 22 such that A-phase solar battery 4a and B-phase solar battery 4b form a ring. Here, A-phase solar battery 4a is disposed on the upper side of light shielding plate 225, and B-phase solar battery 4b is disposed on the upper side of light shielding plate 226.

Light shielding plate 235 is formed in a ring shape. Light shielding plate 235 has a plurality of through holes 236. Respective through holes 236 are provided at certain intervals in a circumferential direction. Each of through holes 236 is formed to have a rectangular shape in which a direction (radial direction) orthogonal to the circumferential direction is a longitudinal direction. An angle (inner angle) defined by two long sides of each through hole 236 is θ1. This means that each through hole 236 is provided in the circumferential direction by a certain angle (2×θ1).

Housing 2 holds a plurality of (two in this example) operation units 301, 302 that are respectively movable relative to housing 2. One operation unit 301, of two operation units 301, 302, is an operation unit for a rotation operation, and other operation unit 302 is an operation unit for a push operation. Operation unit 301 will be hereinafter referred to as “rotation operation unit 301”, while operation unit 302 will be hereinafter referred to as “push operation unit 302”. This means that operation unit 3 includes rotation operation unit 301 and push operation unit 302. Rotation operation unit 301 is held by housing 2 so as to be rotatable about rotation axis Z1 passing through rotation operation unit 301. Rotation axis Z1 renders a virtual line that is a straight line along the up-down direction, passing through the center of rotation operation unit 301. The term “rotation operation” used herein means an operation of rotating rotation operation unit 301 about rotation axis Z1. Push operation unit 302 is held by housing 2 so as to be movable straight along the up-down direction. The term “push operation” used herein means an operation of pushing push operation unit 302 downward.

Rotation operation unit 301 has a circular column shape centered about rotation axis Z1. Rotation operation unit 301 is made of a synthetic resin, for example. An upper surface of rotation operation unit 301 is formed with upper side recess 32 opening in a circular shape. Push operation unit 302 and return spring 35 are received in upper side recess 32. A center portion on a bottom surface of upper side recess 32 is formed with through hole 33 opening in a circular shape. Through hole 33 is a hole passing through rotation operation unit 301 in the up-down direction. A lower end on an outer circumferential surface of rotation operation unit 301 is formed with flange portion 34 projecting in a radial direction of rotation operation unit 301 over the entire circumference of rotation operation unit 301.

A lower surface of rotation operation unit 301 is formed with lower side recess 36 opening in a circular shape. An outer diameter of rotation operation unit 301, excluding flange portion 34, is rather smaller than an inner diameter of opening 231. An outer diameter of flange portion 34 is greater than the inner diameter of opening 231. With the dimensional relationship described above, rotation operation unit 301 is assembled in housing 2 so as to pass through opening 231, and to project upward above the upper surface of housing 2. In this state, flange portion 34 is accommodated between the upper surface of second case 22 and a lower surface of extended portion 232. Therefore, flange portion 34 catches extended portion 232, preventing rotation operation unit 301 from coming off housing 2. Thus, the inner circumferential surface of extended portion 232 serves as a guide whereby rotation operation unit 301 is rotatable about rotation axis Z1. On the outer circumferential surface of rotation operation unit 301, a plurality of antislip grooves each extending longer in the up-down direction are formed over the entire circumference of rotation operation unit 301.

In the description provided below, to distinguish a direction of rotation when a rotation operation is performed with rotation operation unit 301, a counter-clockwise rotation in a planar view, i.e., a rotation in a direction indicated by arrow R1 in FIGS. 6A and 6C, will be referred to as a “normal rotation”. On the other hand, a counter-clockwise rotation in the planar view, i.e., a rotation in a direction indicated by arrow R2 in FIGS. 6A and 6C, will be referred to as a “reverse rotation”.

To the lower side of flange portion 34 of rotation operation unit 301, light shielding plate 235 is fixed. For example, light shielding plate 235 is fixed to rotation operation unit 301 when upward projection 237 of light shielding plate 235 is press-fitted in groove 341 of rotation operation unit 301. Thus, light shielding plate 235 rotates along with rotation (normal rotation or reverse rotation) of rotation operation unit 301. At this time, light shielding plate 235 rotates (normal rotation or reverse rotation) relative to light shielding plates 225, 226, A-phase solar battery 4a, and B-phase solar battery 4b.

In a state illustrated in FIG. 6C, respective through holes 2251 of light shielding plate 225 and respective through holes 236 of light shielding plate 235 are located at the same positions in the up-down direction. Therefore, the quantity of light made incident on A-phase solar battery 4a is maximum. On the other hand, respective through holes 2261 of light shielding plate 226 and respective through holes 236 of light shielding plate 235 partially overlap each other in the up-down direction, and a half of respective through holes 2261 are closed with light shielding plate 235. Therefore, the quantity of light made incident on B-phase solar battery 4b is a half of the maximum light quantity. Then, when rotation operation unit 301 is rotated, overlapping states between respective through holes 236 of light shielding plate 235 and respective through holes 2251, 2261 of light shielding plates 225, 226 are changed. Therefore, the quantity of light made incident on A-phase solar battery 4a and the quantity of light made incident on B-phase solar battery 4b are each changed. This means that a regulation member configured of light shielding plates 225, 226, 235 changes the quantity of light made incident on photovoltaic unit 4 in conjunction with rotation of rotation operation unit 301.

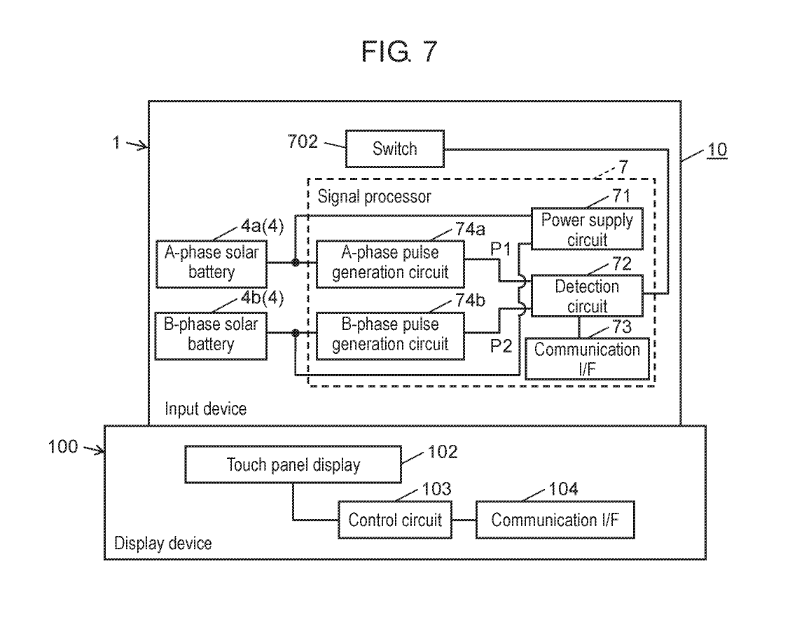

Here, when rotation operation unit 301 is rotated in one direction at a constant speed, waveforms of respective outputs (output voltage or output current) of A-phase solar battery 4a and B-phase solar battery 4b are waveforms having a constant cycle. In the case where each through hole is in a longitudinal shape as in the present exemplary embodiment, the waveform of each output is a triangular wave. In more detail, the waveform of an output of A-phase solar battery 4a is a waveform in which a phase is shifted by π/4 relative to the waveform of an output of B-phase solar battery 4b. A-phase pulse generation circuit 74a electrically connected with A-phase solar battery 4a and B-phase pulse generation circuit 74b electrically connected with B-phase solar battery 4b (see FIG. 7) output pulse signals P1, P2, respectively. Pulse signals P1, P2 are pulse signals in which the cycles are the same and the phases are shifted by π/4 from each other. Further, whether pulse signal P2 becomes a leading phase or a lagging phase relative to pulse signal P1 is switched depending on an operating direction of rotation operation unit 301. This means that the regulation member configured of light shielding plates 225, 226, 235 is formed to change the quantity of light made incident on photovoltaic unit 4 differently, depending on the case where rotation operation unit 301 is rotated in one direction and the case where rotation operation unit 301 is rotated in an opposite direction. In other words, the regulation member gives a different phase to the quantity of light made incident on A-phase solar battery 4a and to the quantity of light made incident on B-phase solar battery 4b, when rotation operation unit 301 is rotated.

Input device 1 also has a click mechanism of giving a click feeling (operating feeling) to a user who operates rotation operation unit 301 when performing rotation operation of rotation operation unit 301. The click mechanism is configured of click spring 31 attached to rotation operation unit 301, and a plurality of projections 221 provided on the upper surface of second case 22.

Click spring 31 is formed of a ring-shaped plate spring in a planar view. At both ends in the left-right direction of click spring 31, projections 311 projecting downward are formed. Click spring 31 is attached to rotation operation unit 301 such that projections 311 face downward. Here, a bottom surface of lower side recess 36 is provided with cylindrical portion 37 projecting downward. The lower surface of cylindrical portion 37 has projections to be inserted in two holes 312 of click spring 31 respectively. In a state where projections of cylindrical portion 37 are inserted in holes 312 of click spring 31, when the projections are melted by heat, click spring 31 is attached to the lower surface of cylindrical portion 37.

The upper surface of second case 22 has a plurality of projections 221 formed to be aligned along the circumferential direction. Projections 221 are provided at positions opposite to a ring portion of click spring 31 attached to rotation operation unit 301. Respective projections 221 are disposed at certain intervals in a circumferential direction. Accordingly, on the upper surface of second case 22, a portion opposite to the ring portion of click spring 31 has projecting portions (projections 221) and recesses alternately formed along the circumferential direction of the ring portion of click spring 31. Projecting portions and recesses are provided on the entire circumference of click spring 31. Projections 221 face the lower surface of click spring 31. Projections 311 of click spring 31 are brought into contact with projections 221.

As such, each time rotation operation unit 301 is rotated by a predetermined rotation angle, projection 311 goes over the upper surfaces of projections 221 while click spring 31 is elastically deformed. Thus, click feeling (operation feeling) is given to the user of rotation operation unit 301.

Push operation unit 302 has a disk shape centered about rotation axis Z1. Push operation unit 302 is made of a synthetic resin, for example. A lower surface of push operation unit 302 has projection part 39 projecting downward. Push operation unit 302 is to be engaged with rotation operation unit 301 such that projection part 39 is inserted in through hole 33. Projection part 39 projects downward from the lower end of through hole 33. The lower surface of push operation unit 302 has catch hooks projecting downward at both side positions interposing projection part 39. The catch hook catches rotation operation unit 301, preventing push operation unit 302 from coming off rotation operation unit 301. The lower end of projection part 39 faces printed board 701 disposed on the upper surface of second case 22. On printed board 701, switch 702 like a membrane switch is mounted at a position opposite to the lower end of projection part 39. When the user pushes push operation unit 302, projection part 39 moves to the lower side, and switch 702 is push-operated by the lower end of projection part 39.

Input device 1 further includes return spring 35 that causes, when a push operation is performed with push operation unit 302, push operation unit 302 to return to a position (reference position) at which push operation unit 302 has lied before the operation has been performed. Return spring 35 is formed of a coil spring. When a push operation is performed with push operation unit 302, return spring 35 is compressed to apply a force toward pushing push operation unit 302 to push operation unit 302.

Attaching portion 8 is a sucker. Attaching portion 8 is held by housing 2 such that an adsorption surface of attaching portion 8 is exposed from a lower surface of housing 2. Attaching portion 8 is a sucker made of a transparent material. Light passing through attaching portion 8 is also made incident on photovoltaic unit 4. When the lower surface of input device 1 is pressed against attaching surface 101, attaching portion 8 that is a sucker adheres to attaching surface 101 by suction. As described above, input device 1 is detachably attached to display device 100.

Input device 1 also includes slider 81, holding cam 82, holding bar 83, and presser spring 84, as a holding mechanism for holding attaching portion 8. Slider 81, holding cam 82, holding bar 83, and presser spring 84 are disposed between first case 21 and second case 22.

The center of an upper portion of attaching portion 8 is provided with projection 801 projecting upward. Projection 801 has holding hole 802 passing through projection 801 in the front-rear direction. Holding bar 83 is inserted into holding hole 802. Both ends in the front-rear direction of holding bar 83 are held by holding cam 82. Holding cam 82 includes cam body 823 extending longer in the front-rear direction, and a pair of bearing portions 821 projecting downward from cam body 823. Pair of bearing portions 821 hold holding bar 83. Holding cam 82 has, on both sides of pair of bearing portions 821 in the front-rear direction, cam pieces 822 respectively. A lower surface of cam piece 822 is a curved surface projecting downward.

Slider 81 has a rectangular frame shape extending longer in the left-right direction in a planar view. At a center portion of slider 81, rectangular hole 811 passing in a thickness direction of slider 81 is formed. On an upper surface of slider 81, pairs of first dent 812 and second dent 813 each recessed downward are provided respectively on both sides in the front-rear direction of rectangular hole 811. This means that a pair of first dent 812 and second dent 813 is provided to the front side of rectangular hole 811, and a pair or first dent 812 and second dent 813 is also provided to the rear side of rectangular hole 811. Second dent 813 has a larger (deeper) recessed amount than that of first dent 812, and is provided continuing from first dent 812 on the right side of first dent 812. Therefore, both side portions in the front-rear direction of rectangular hole 811 on the upper surface of slider 81 are shaped in a stepwise manner by first dents 812 and second dents 813.

Holding cam 82 is assembled from above into slider 81. Here, a pair of bearing portions 821 is inserted from above into rectangular hole 811. Further, a pair of cam pieces 822 is positioned on both sides in the front-rear direction of slider 81. This means that on both side portions of slider 81 in the front-rear direction, cam pieces 822 on both sides of holding cam 82 in the front-rear direction are disposed. Further, presser spring 84 applies a force to holding cam 82 to push holding cam 82 downward. Therefore, holding cam 82 is pressed against the upper surface of slider 81.

Slider 81 is then held by housing 2 in a state where relative movement with respect to housing 2 in the up-down direction and the front-rear direction is restricted. In other words, slider 81 is movable relative to housing 2 only in the left-right direction. Meanwhile, holding cam 82 is inserted into second groove 222 of second case 22 from below. Holding cam 82 is held by housing 2 in a state where relative movement with respect to housing 2 in the left-right direction and the up-down direction is restricted. In other words, holding cam 82 is movable relative to housing 2 only in the up-down direction.

Therefore, when slider 81 moves relative to housing 2 in the left-right direction, holding cam 82 moves relative to housing 2 in the up-down direction. This means that since the upper surface of slider 81 is formed in a stepwise manner by first dent 812 and second dent 813, the position of holding cam 82 in the up-down direction (also referred to as “height”) is changed in a stepwise manner along with movement of slider 81 in the left-right direction. The height of holding cam 82 is the highest when cam body 823 lies on the left side of first dent 812. Holding cam 82 is gradually lowered in height in an order of a position where cam body 823 lies in first dents 812 and a position where cam body 823 lies in second dents 813. Therefore, when slider 81 moves leftward relative to housing 2, holding cam 82 is lowered in height gradually. When slider 81 moves rightward relative to housing 2, holding cam 82 rises in height gradually. When holding cam 82 changes in height, projection 801 held by holding cam 82 via holding bar 83 moves in the up-down direction.

With the holding mechanism configured as described above, a holding force applied by attaching portion 8 to display device 100 of input device 1 changes as slider 81 moves. The term “holding force” used herein means a force with which, while input device 1 is attached to display device 100, attaching portion 8 holds input device 1 on display device 100. The greater the holding force, the less the possibility of input device 1 of coming off display device 100. When attaching portion 8 is a sucker, an adsorption force applied by attaching portion 8 to attaching surface 101 corresponds to the “holding force”.

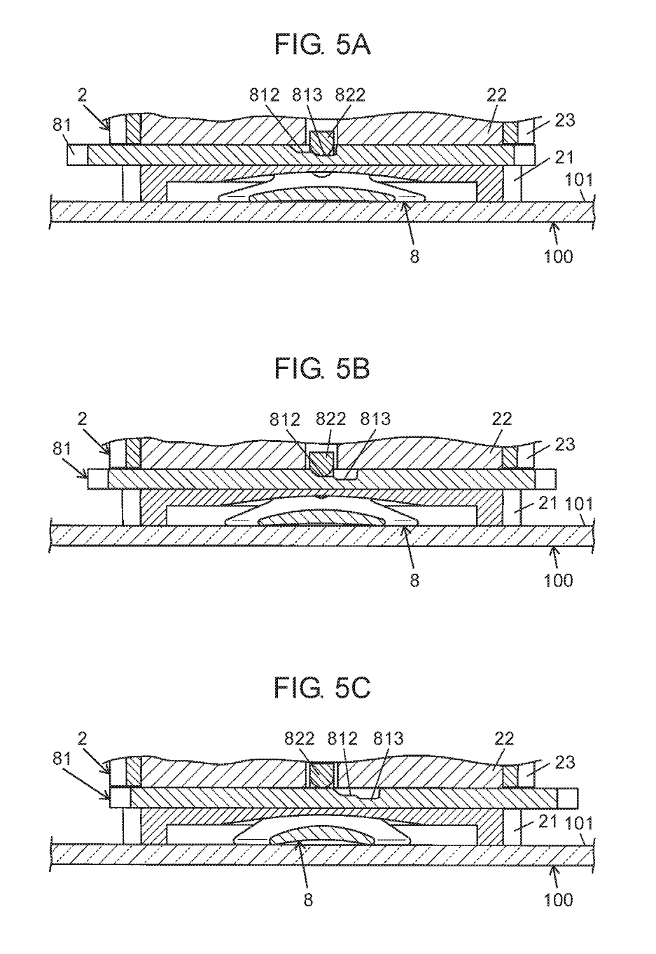

In short, as illustrated in FIG. 5A, when slider 81 lies at a left end position of a movable range, cam piece 822 lies in second dent 813. Therefore, holding cam 82 lies at a lower end position of the movable range. At this time, projection 801 of attaching portion 8 (see FIG. 1) lies at a lower end position of the movable range. A state of input device 1 illustrated in FIG. 5A is referred to as a “positioning state”. Input device 1 is first attached to attaching surface 101 of display device 100 in the positioning state.

As illustrated in FIG. 5B, in a state where slider 81 lies at an intermediate position of the movable range, cam piece 822 lies in first dent 812. Therefore, holding cam 82 lies at an intermediate position of the movable range. At this time, projection 801 of attaching portion 8 lies at an intermediate position of the movable range. A state of input device 1 illustrated in FIG. 5B is referred to as a “temporarily fixed state”. While input device 1 is attached to attaching surface 101 of display device 100, the state of input device 1 can be switched from the positioning state to the temporarily fixed state. Thus, projection 801 of attaching portion 8 is lifted upward, whereby a space between the lower surface of attaching portion 8 and attaching surface 101 is expanded. Accordingly, a degree of vacuum in this space is increased (pressure is lowered).

As illustrated in FIG. 5C, when slider 81 lies at a right end position of the movable range, cam piece 822 lies on the left side of first dent 812. Therefore, holding cam 82 lies at an upper end position of the movable range. At this time, projection 801 of attaching portion 8 lies at an upper end position of the movable range. A state of input device 1 illustrated in FIG. 5C is referred to as a “fully fixed state”. While input device 1 is attached to attaching surface 101 of display device 100, the state of input device 1 can be switched from the temporarily fixed state to the fully fixed state. Thus, projection 801 of attaching portion 8 is further lifted upward, whereby the space between the lower surface of attaching portion 8 and attaching surface 101 is further expanded. Accordingly, the degree of vacuum in this space is further increased (pressure is further lowered).

When a user attaches input device 1 to display device 100, the user first attaches input device 1 in the positioning state (a state where cam piece 822 lies in second dent 813) to attaching surface 101 of display device 100. The user then moves slider 81 rightward to switch the state of input device 1 in an order of the temporarily fixed state and the fully fixed state. As a result, the degree of vacuum in the space between the lower surface of attaching portion 8 and attaching surface 101 increases gradually, and accordingly input device 1 is securely attached to display device 100. When the user removes input device 1 from display device 100, the user moves slider 81 leftward to switch the state of input device 1 in an order of the fully fixed state, the temporarily fixed state, and the positioning state. As a result, the degree of vacuum in the space between the lower surface of attaching portion 8 and attaching surface 101 lowers gradually, and accordingly input device 1 can be easily removed from display device 100.

As illustrated in FIG. 2, signal processor 7 includes printed board 701 and electronic parts including switch 702 and integrated circuit (IC) 703. In addition to switch 702 and IC 703, signal processor 7 further includes other electronic parts, such as capacitors. These electronic parts are mounted on printed board 701.

As illustrated in FIG. 7, signal processor 7 includes power supply circuit 71, detection circuit 72, and communication interface 73. The term “interface” will be hereinafter referred to as “I/F”. Signal processor 7 further includes A-phase pulse generation circuit 74a and B-phase pulse generation circuit 74b. Respective functions of power supply circuit 71, detection circuit 72, communication I/F 73, A-phase pulse generation circuit 74a, and B-phase pulse generation circuit 74b are realized by electronic parts mounted on printed board 701. A-phase pulse generation circuit 74a is electrically connected with A-phase solar battery 4a, and B-phase pulse generation circuit 74b is electrically connected with B-phase solar battery 4b.

Power supply circuit 71 includes capacitors, and is configured to store charges generated by A-phase solar battery 4a and B-phase solar battery 4b in the capacitors. Power supply circuit 71 generates power for operating signal processor 7.

A-phase pulse generation circuit 74a detects a change in an output (output voltage or output current) of A-phase solar battery 4a generated along with rotation of rotation operation unit 301, and outputs pulse signal P1.

B-phase pulse generation circuit 74b detects a change in an output (output voltage or output current) of B-phase solar battery 4b generated along with rotation of rotation operation unit 301, and outputs pulse signal P2.

Detection circuit 72 generates detection information corresponding to an operation of rotation operation unit 301, based on pulse signals P1, P2 input from A-phase pulse generation circuit 74a and B-phase pulse generation circuit 74b, respectively. Here, detection circuit 72 detects a quantity of rotation (rotation angle) of rotation operation unit 301 from a number of pulses of pulse signals P1, P2. Detection circuit 72 also detects a rotation direction of rotation operation unit 301 by detecting whether pulse signal P2 is a leading phase or a lagging phase relative to pulse signal P1. Accordingly, detection circuit 72 can detect the quantity of rotation and the rotation direction of rotation operation unit 301 from pulse signals P1, P2, whereby detection circuit 72 generates detection information showing the quantity of rotation and the rotation direction of rotation operation unit 301.

Detection circuit 72 also generates detection information corresponding to an operation of push operation unit 302, based on a signal input from switch 702.

Communication I/F 73 transmits detection information generated by detection circuit 72, to display device 100 via wireless communication of radio waves used as a medium. Specifically, upon receiving detection information from detection circuit 72, communication I/F 73 modulates a carrier wave with use of detection information to transmit the detection information through carrier wave. Communication I/F 73 follows a communication method such as WiFi (registered trademark), Bluetooth (registered trademark), or specified small power radio. The specified small power radio is small power radio requiring neither certification nor registration. The specified small power radio is small power radio utilizing a radio wave of 420 MHz band or 920 MHz band in Japan, for example.

In addition to touch panel display 102 (display unit), display device 100 is provided with control circuit 103 and communication I/F 104 (communication unit). To a display surface (attaching surface 101) of touch panel display 102, attaching portion 8 of input device 1 is attached. Communication I/F 104 is configured to perform wireless communication with communication I/F 73. Therefore, display device 100 receives detection information transmitted from input device 1 via wireless communication. Control circuit 103 controls display content displayed on touch panel display 102. For example, control circuit 103 controls display content to be displayed on touch panel display 102 in accordance with detection information received by communication I/F 104, and allows the display content to be displayed on touch panel display 102.

### (2.2) Operation

An operation of input device 1 according to the present exemplary embodiment will now be described.

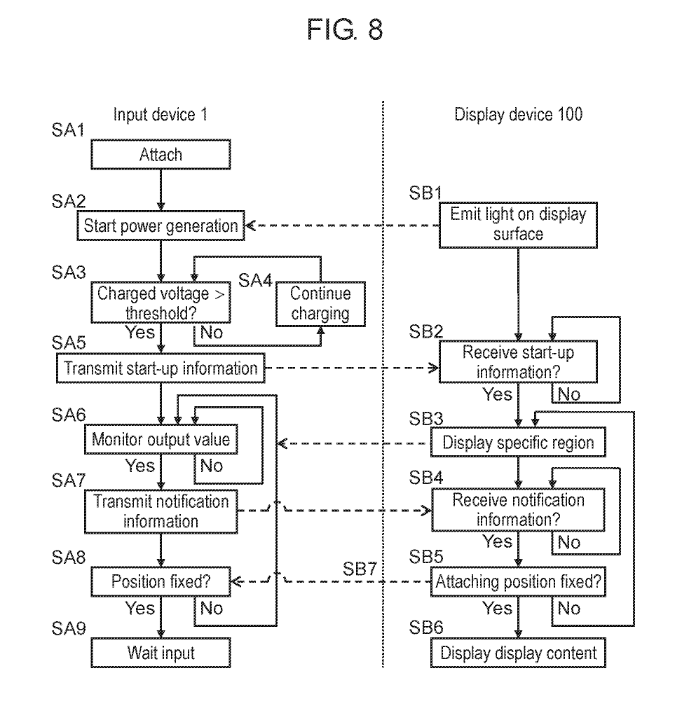

First, a position search operation from when a user attaches input device 1 to attaching surface 101 of display device 100 until display device 100 searches for an attaching position of input device 1 will be described with reference to a flowchart of FIG. 8.

A user attaches input device 1 to attaching surface 101 of display device 100 (SA1). The user also operates touch panel display 102 of display device 100 to perform operation enabling operation using input device 1. Then, control circuit 103 controls touch panel display 102 to allow the entire display surface (attaching surface 101) to emit light (SB1). At this time, light emitted from the display surface is made incident on A-phase solar battery 4a and B-phase solar battery 4b of input device 1 via first case 21 and second case 22.

Then, A-phase solar battery 4a and B-phase solar battery 4b start power generation (SA2). When A-phase solar battery 4a and B-phase solar battery 4b start power generation, power supply circuit 71 charges a capacitor with electromotive force generated by A-phase solar battery 4a and B-phase solar battery 4b. When a charging voltage of the capacitor is equal to or smaller than a threshold (No at SA3), power supply circuit 71 continues charging of the capacitor (SA4). When the charging voltage of the capacitor exceeds the threshold (Yes at SA3), signal processor 7 transmits start-up information showing that input device 1 is in an attached state, from communication I/F 73 to display device 100 via wireless communication (SA5). Signal processor 7 may transmit start-up information from communication I/F 73 to display device 100 via wireless communication when a signal is input from switch 702 in response to an operation of push operation unit 302 (notification operation unit) in a state where the charging voltage of the capacitor is larger than the threshold. Signal processor 7 may transmit start-up information from communication I/F 73 to display device 100 via wireless communication when the user performs a touch operation on touch panel display 102 in a state where the charging voltage of the capacitor is larger than the threshold.

Control circuit 103 of display device 100 waits to receive start-up information (SB2). When communication I/F 104 receives start-up information transmitted from input device 1 via wireless communication (Yes at SB2), control circuit 103 allows touch panel display 102 to display a specific region (SB3).

A specific region is display content displayed on a display surface for detecting the attaching position of input device 1. A position of the specific region moves as time passes. Optical energy emitted from the specific region differs from optical energy emitted from a region other than the specific region on the display surface. Optical energy emitted from the specific region is smaller than optical energy emitted from a region other than the specific region on the display surface, for example. Here, optical energy means a quantity of light per unit area, for example.

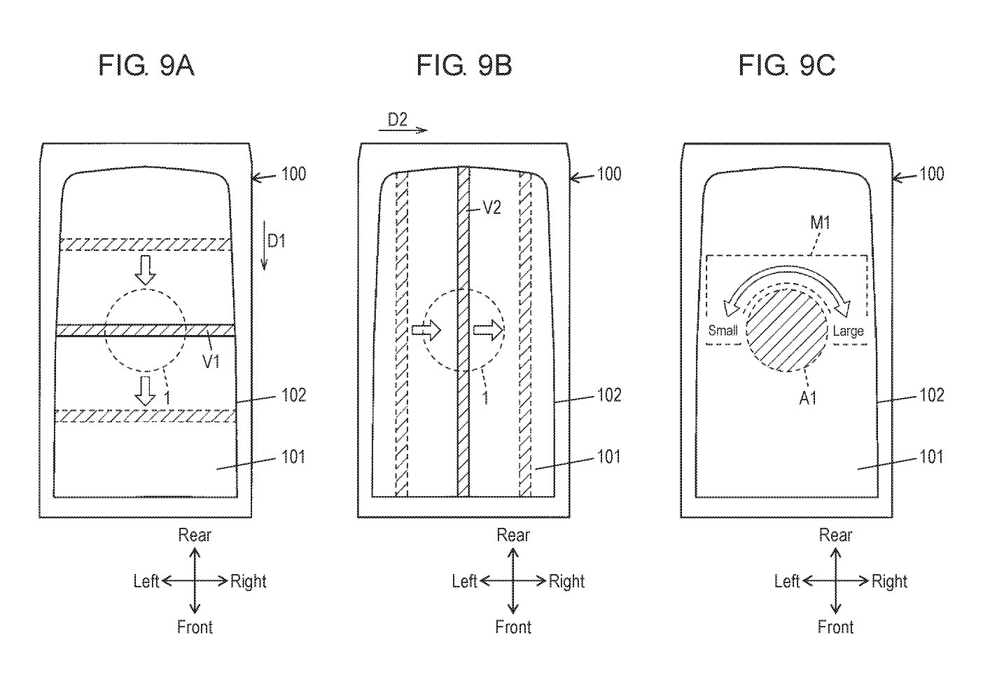

FIGS. 9A and 9B are exemplary illustrations of a specific region displayed on the display surface (attaching surface 101) of touch panel display 102. Specific region V1 illustrated in FIG. 9A moves along a first direction (direction of arrow D1) on the display surface. Specific region V2 illustrated in FIG. 9B moves along a second direction (direction of arrow D2) crossing the first direction on the display surface. In the present exemplary embodiment, the first direction and the second direction are orthogonal to each other.

Specific region V1 illustrated in FIG. 9A is used for searching for the attaching position of input device 1 in a front-rear direction (first direction). Specific region V1 is a band-shaped region extending up to both ends of the display surface along a left-right direction. Control circuit 103 controls the display content displayed on touch panel display 102 such that the position of specific region V1 moves frontward (direction of arrow D1) from a rear end to a front end of the display surface as time passes.

Specific region V2 illustrated in FIG. 9B is used for searching for the attaching position of input device 1 in the left-right direction (second direction). Specific region V2 is a band-shaped region extending up to both ends of the display surface along the front-rear direction. Control circuit 103 controls the display content displayed on touch panel display 102 such that the position of specific region V2 moves rightward (direction of arrow D2) from a left end to a right end of the display surface as time passes.

The specific region is not limited to a band-shaped region. For example, the specific region may be a spot-shaped region smaller in size than input device 1. Control circuit 103 may move the spot-shaped specific region from upper left to lower right of the display surface to thereby search for the position of input device 1. The shape of the specific region and the path through which the specific region is moved can be changed as appropriate according to the shape of input device 1 and the shape of the display surface.

Control circuit 103 displays specific region V1 illustrated in FIG. 9A on touch panel display 102 to search for the attaching position of input device 1 in the front-rear direction.

After transmitting the start-up information to display device 100 via wireless communication, signal processor 7 of input device 1 monitors output values of photovoltaic unit 4 (output values of both A-phase solar battery 4a and B-phase solar battery 4b) (SA6).

On the display surface of touch panel display 102, when specific region V1 moves frontward as time passes and specific region V1 overlaps the attaching position of input device 1 in an up-down direction, output values of photovoltaic unit 4 drop. When a drop range of output values of photovoltaic unit 4 exceeds a prescribed value, signal processor 7 transmits notification information indicating that specific region V1 and the attaching position overlap each other, from communication I/F 73 to display device 100 via wireless communication (SA7). This means that when a predetermined change occurs in the electric power generated by photovoltaic unit 4, signal processor 7 transmits notification information via wireless communication.

In a state where specific region V1 is displayed on touch panel display 102, control circuit 103 waits to receive notification information from input device 1 (SB4). Then, when communication I/F 104 receives the notification information (Yes at SB4), control circuit 103 determines the position of specific region V1 at this moment to be the attaching position of input device 1 in the front-rear direction. Then, control circuit 103 determines whether or not the attaching position is fixed (SB5). Here, since only the attaching position in the front-rear direction is fixed (No at SB5), control circuit 103 searches for the attaching position of input device 1 in the left-right direction. This means that control circuit 103 displays specific region V2 illustrated in FIG. 9B on touch panel display 102.

After transmitting the notification information to display device 100 via wireless communication, signal processor 7 of input device 1 determines whether or not the attaching position is fixed (SA8). When a number of times of transmission of the notification information is one, signal processor 7 determines that the attaching position is not fixed (No at SA8), and monitors the output values of photovoltaic unit 4 again (SA6).

On the display surface of touch panel display 102, when specific region V2 moves rightward as time passes and specific region V2 overlaps the attaching position of input device 1 in the up-down direction, output values of photovoltaic unit 4 drop. When a drop range of output values of photovoltaic unit 4 exceeds a prescribed value, signal processor 7 transmits notification information indicating that specific region V2 and the attaching position overlap each other, from communication I/F 73 to display device 100 via wireless communication (SA7). This means that when a predetermined change occurs in the electric power generated by photovoltaic unit 4, signal processor 7 transmits notification information via wireless communication.

After transmitting the notification information from communication I/F 73 to display device 100 via wireless communication, signal processor 7 determines whether or not the attaching position is fixed (SA8). At this time, since the number of times of transmission of the notification information is two, signal processor 7 determines that the attaching position is fixed (Yes at SA8). Then, signal processor 7 waits for an operation input using rotation operation unit 301 and push operation unit 302 (SA9).

In a state where specific region V2 is displayed on touch panel display 102, control circuit 103 waits to receive notification information from input device 1 (SB4). Then, when communication I/F 104 receives the notification information (Yes at SB4), control circuit 103 determines the position of specific region V2 at this moment to be the attaching position of input device 1 in the left-right direction. Then, control circuit 103 determines whether or not the attaching position is fixed (SB5). Here, since both the attaching position in the front-rear direction and the attaching position in the left-right direction are fixed (Yes at SB5), control circuit 103 allows input display content provided for input operation using input device 1 to be displayed on touch panel display 102 (SB6).

FIG. 9C illustrates an example of the input display content. Control circuit 103 allows the optical energy of region A1 corresponding to the attaching position of input device 1 to be larger than optical energy of another region to thereby increase the electric power generated by photovoltaic unit 4. Control circuit 103 also displays display content M1 that is input display content related to input operation, on touch panel display 102, in a region other than the attaching position of input device 1, based on the attaching position of input device 1. Display content M1 illustrated in FIG. 9C shows input display content for controlling a device to be operated by display device 100 based on the operation information input with use of input device 1. In the example of FIG. 9C, display content M1 related to input operation is an operation guide for input operation. In more detail, display content M1 is display content showing a relation between an operating direction of rotation operation unit 301 and magnitude of a quantity of operation. Display content M1 is not limited to a guide for operation. Display content M1 may be content prompting display or content showing a state of a device to be operated. Control circuit 103 controls the position of display content M1 displayed around the attaching position of input device 1 according to a detection result of the attaching position of input device 1.

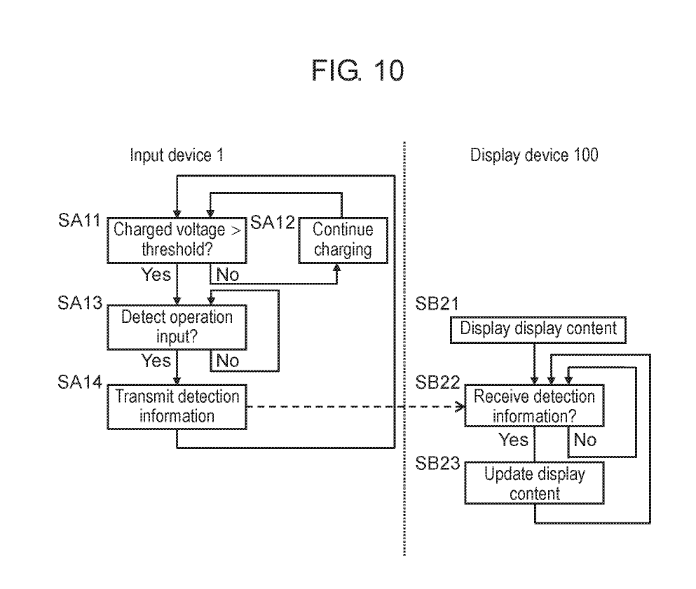

Next, an input receiving process when a user performs input with use of input device 1 will be described with reference to the flowchart of FIG. 10.

Control circuit 103 of display device 100 controls the input display content to thereby display the input display content on touch panel display 102 (SB21).

In input device 1, photovoltaic unit 4 generates power, and power supply circuit 71 charges a capacitor. When a charging voltage of a capacitor is equal to or smaller than a threshold (No at SA11), power supply circuit 71 continues charging of the capacitor (SA12). When the charging voltage of the capacitor becomes larger than the threshold (Yes at SA11), signal processor 7 starts monitoring of an operation input by operation unit 3 (SA13). Then, when signal processor 7 detects an operation input from operation unit 3 (Yes at S13), signal processor 7 transmits detection information corresponding to the operation input from communication I/F 73 to display device 100 via wireless communication (SA14). Then, signal processor 7 returns to SA11 and continues processing.

On the other hand, after control circuit 103 of display device 100 displays the input display content on touch panel display 102, control circuit 103 becomes a reception waiting state in which control circuit 103 waits to receive detection information transmitted from input device 1 via wireless communication (SB22). Then, when communication I/F 104 receives detection information (Yes at SB22), control circuit 103 controls the device to be operated in response to the detection information. Then, control circuit 103 updates the input display content displayed on touch panel display 102 in response to the detection information (SB23). Then, control circuit 103 returns to SB22, and waits to receive detection information.

In the reception waiting state, control circuit 103 controls display content such that the attaching position of input device 1 on the display surface emits light. In detail, in the reception waiting state, control circuit 103 may control the display content such that optical energy emitted from the attaching position of input device 1 on the display surface becomes predetermined optical energy. Here, it is only necessary that predetermined optical energy is optical energy larger than optical energy required for generating electric power, by photovoltaic unit 4, required for operating signal processor 7.

### (3) Effect

According to input device 1 of the present exemplary embodiment described above, photovoltaic unit 4 can generate electric power with use of light made incident from a side where attaching portion 8 is disposed in housing 2. Then, signal processor 7 operates by receiving the electric power generated by photovoltaic unit 4. Signal processor 7 transmits detection information generated in response to movement of operation unit 3, via wireless communication. Accordingly, input device 1 can detect operation of operation unit 3 without using a touch panel. In a state where attaching portion 8 is not attached, a quantity of electric power generated by photovoltaic unit 4 decreases. Accordingly, input device 1 can suppress erroneous transmission of detection information when input device 1 is not attached.

As in the present exemplary embodiment, when attaching portion 8 is a sucker, the attaching position of input device 1 can be changed easily. In a case where attaching portion 8 is a sucker, an attached state of housing 2 to display device 100 may vary. However, input device 1 detects movement of operation unit 3, and transmits detection information corresponding to movement of operation unit 3 via wireless communication. Therefore, input device 1 can detect an operation of operation unit 3 stably even when the attached state of housing 2 to display device 100 varies.

In input device 1 of the present exemplary embodiment, housing 2 includes transmission parts (first case 21, second case 22, attaching portion 8, and the like) that transmit light made incident from a side where attaching portion 8 is disposed in housing 2. Accordingly, since photovoltaic unit 4 can generate power with the light passing through the transmission part, the quantity of electric power generated by photovoltaic unit 4 increases.

In input device 1 of the present exemplary embodiment, signal processor 7 transmits notification information via wireless communication when a predetermined change occurs in electric power generated by photovoltaic unit 4. In a state where a specific region is displayed on the display surface of display device 100, when a predetermined change occurs in the electric power generated by photovoltaic unit 4, notification information is transmitted from input device 1 to display device 100 via wireless communication. Accordingly, display device 100 can estimate the attaching position of input device 1 on the display surface, on the basis of the notification information transmitted from input device 1.

Input device 1 of the present exemplary embodiment also includes a regulation member. The regulation member changes a quantity of light made incident on photovoltaic unit 4 in conjunction with movement of rotation operation unit 301. Then, signal processor 7 detects movement of rotation operation unit 301 based on a change in the electric power generated by photovoltaic unit 4, and transmits detection information generated in response to a detection result of the movement of rotation operation unit 301 via wireless communication.

Thus, signal processor 7 can detect movement of rotation operation unit 301 based on a change in the electric power generated by photovoltaic unit 4, and transmit detection information generated in response to a detection result of the movement of rotation operation unit 301 via wireless communication.

In input device 1 of the present exemplary embodiment, rotation operation unit 301 is disposed rotatably in either direction relative to housing 2. The regulation member is formed to change the quantity of light made incident on photovoltaic unit 4 differently, depending on the case where rotation operation unit 301 is rotated in one direction and the case where rotation operation unit 301 is rotated in an opposite direction.

Thus, signal processor 7 can detect rotational movement in either direction of rotation operation unit 301 based on a change in the electric power generated by photovoltaic unit 4. Therefore, signal processor 7 can transmit detection information generated according to a detection result of the rotational movement in either direction of rotation operation unit 301, via wireless communication.

In input device 1 of the present exemplary embodiment, rotation operation unit 301 is disposed rotatably in either direction relative to housing 2.

Photovoltaic unit 4 includes A-phase solar battery 4a and B-phase solar battery 4b. The regulation member gives a different phase to the quantity of light made incident on A-phase solar battery 4a and to the quantity of light made incident on B-phase solar battery 4b, when rotation operation unit 301 is rotated.

Thus, signal processor 7 can detect rotational movement in either direction of rotation operation unit 301 based on a phase difference between an output of A-phase solar battery 4a and an output of B-phase solar battery 4b. Therefore, signal processor 7 can transmit detection information generated according to a detection result of the rotational movement in either direction of rotation operation unit 301, via wireless communication.

As in the present exemplary embodiment, housing 2 may have a contact portion (peripheral wall 215) in contact with an attaching target portion in a state where housing 2 is attached to the attaching target portion (attaching surface 101) via attaching portion 8. Thus, an attached state of housing 2 with respect to the attaching surface 101 is stabilized, and a distance between photovoltaic unit 4 and attaching surface 101 (display surface) is kept constant. Therefore, the quantity of electric power generated by photovoltaic unit 4 is stabilized.

According to input system 10 of the present exemplary embodiment, photovoltaic unit 4 can generate electric power with use of light of display device 100 made incident from a side where attaching portion 8 is disposed in housing 2. Then, signal processor 7 operates by receiving the electric power generated by photovoltaic unit 4. Signal processor 7 transmits detection information generated in response to movement of operation unit 3, via wireless communication. Accordingly, input system 10 can detect operation of operation unit 3 without using a touch panel.

In input system 10 of the present exemplary embodiment, in the reception waiting state, control circuit 103 of display device 100 controls display content such that the attaching position of input device 1 on the display surface emits light. Thus, photovoltaic unit 4 can generate electric power required for operation of signal processor 7.

Operation unit 3 of input device 1 includes a notification operation unit (push operation unit 302) to be operated for notifying that input device 1 is in an attached state where input device 1 is attached to the display surface. Signal processor 7 transmits start-up information via wireless communication when the notification operation unit is operated. Thus, upon receipt of the start-up information, display device 100 can recognize that input device 1 is attached to the display surface. When display device 100 recognizes that input device 1 is attached to the display surface, display device 100 can start a process of estimating the attaching position of input device 1 on the display surface. Push operation unit 302 may not be used only for transmitting start-up information, but also be used for other purposes in the input receiving process.

In input device 1 of the present exemplary embodiment, signal processor 7 transmits notification information via wireless communication when a predetermined change occurs in electric power generated by photovoltaic unit 4. When control circuit 103 of display device 100 receives the notification information in a state where a specific region is displayed on the display surface, control circuit 103 estimates the attaching position of input device 1 on the display surface from the position of the specific region when receiving the notification information.

As described above, input device 1 can detect the specific region with use of photovoltaic unit 4. Accordingly, display device 100 can estimate the attaching position of input device 1 on the basis of the notification information received from input device 1.

In input system 10 of the present exemplary embodiment, the specific region is in a band shape, and moves along a first direction on the display surface and a second direction crossing the first direction on the display surface.

Thus, display device 100 can estimate the attaching position of input device 1 more accurately.

In input system 10 of the present exemplary embodiment, optical energy emitted from the specific region is smaller than optical energy emitted from a region other than the specific region on the display surface. Accordingly, optical energy emitted from a region other than the specific region is larger than the optical energy emitted from the specific region. Therefore, the quantity of electric power generated by photovoltaic unit 4 increases in the position searching operation.

In input system 10 of the present exemplary embodiment, control circuit 103 of display device 100 controls the display content such that optical energy emitted from the attaching position of input device 1 on the display surface becomes a predetermined optical energy, in response to a result of estimating the attaching position of input device 1 on the display surface. Thus, the quantity of electric power generated by photovoltaic unit 4 increases.

In input system 10 of the present exemplary embodiment, control circuit 103 of display device 100 controls a position of the display content displayed around the attaching position of input device 1, in response to a result of estimating the attaching position of input device 1 on the display surface. Thus, the display content displayed on the display surface is less likely to be interrupted by input device 1.

### (4) Modification

Modifications to the first exemplary embodiment will now be described.

Wireless communication to be performed by signal processor 7 is not limited to wireless communication using radio waves as a medium, but may be, for example, optical wireless communication using an optical medium, such as infrared ray and visible light. In this case, signal processor 7 transmits detection information to display device 100 through optical wireless communication.

It is not necessary that housing 2 includes first case 21, second case 22, and a third case. For example, housing 2 may be configured of one case, two cases, or four or more cases. Further, a coupling structure between first case 21 and second case 22 is not limited to a coupling structure using a screw, but may be another coupling structure such as a snap-fit structure for coupling with elastic claws, or laser welding.

Housing 2 may be partially or wholly made of metal. Similarly, rotation operation unit 301 may be partially or wholly made of metal, and push operation unit 302 may be partially or wholly made of metal.

The respective operation units are not limited to rotation operation unit 301 for rotation operation and push operation unit 302 for push operation, but may be a slide operation unit for slide operation, for example. Further, each of the operation units may have a lever structure that is operated by tilting about a supporting point like a handle of a toggle switch, for example.

In addition, the configuration of input device 1 is not limited to one having two operation units (rotation operation unit 301 and push operation unit 302) as illustrated in the first exemplary embodiment, but may be one having three or more operation units 3. When input device 1 includes a plurality of operation units, the plurality of operation units may be structured identically (e.g., may all be used for rotation operation). Otherwise, input device 1 may include only one operation unit.

Attaching portion 8 held by input device 1 is not limited to a sucker. For example, attaching portion 8 may be a magnet for attaching housing 2 to attaching surface 101 with a magnetic force, or an adhesive member having an adhesive force capable of attaching housing 2. This means that it is only necessary that attaching portion 8 is a member for attaching input device 1 to attaching surface 101 in a detachable state.

Power supply circuit 71 may have a secondary battery, and a charging circuit that charges the secondary battery with electric power generated by photovoltaic unit 4. With this configuration, when voltage of the secondary battery drops, the charging circuit of power supply circuit 71 charges the secondary battery, whereby signal processor 7 can operate with the electric power charged in the secondary battery. Thus, signal processor 7 can operate even though power supply circuit 71 does not charge a capacitor each time a search operation is performed.

In the search operation described in “(2.2) Operation”, when the attaching position of input device 1 is fixed (Yes at SB5), control circuit 103 may transmit a notification signal for notifying that the attaching position is fixed, from communication I/F 104 to input device 1 (SB7). In that case, when communication I/F 73 receives the notification signal transmitted from display device 100, signal processor 7 of input device 1 may determine that the attaching position of input device 1 is fixed on display device 100. While communication I/F 73 and communication I/F 104 perform wireless communication using radio waves as a medium, communication I/F 73 and communication I/F 104 may perform optical wireless communication using light as a medium. In the case where communication I/F 73 performs optical wireless communication using light as a medium, A-phase solar battery 4a or B-phase solar battery 4b may also be used as a light receiving unit that receives light in communication I/F 73, or a light receiving element provided for communication may be used as the light receiving unit.

While the configuration of photovoltaic unit 4 includes A-phase solar battery 4a and B-phase solar battery 4b, a configuration including only one solar battery is also adoptable. In such a configuration, each through hole 236 of light shielding plate 235 is in a triangular shape asymmetric to a radial direction, for example. With this configuration, the regulation member can differently change the quantity of light made incident on photovoltaic unit 4 configured of only one solar battery, depending on the case where rotation operation unit 301 is rotated in one direction and the case where rotation operation unit 301 is rotated in an opposite direction. Thus, signal processor 7 can detect rotational movement in either direction of rotation operation unit 301 with only one solar battery.

While the first direction and the second direction illustrated in FIGS. 9A and 9B are orthogonal to each other, they may not be orthogonal to each other. It is only necessary that the first direction and the second direction cross each other to search for the attaching position of input device 1.

Moreover, a phase difference between a waveform of an output of A-phase solar battery 4a and a waveform of an output of B-phase solar battery 4b is not limited to π/4. Signal processor 7 can detect the rotational movement in either direction of rotation operation unit 301 unless the phase different is 0 or π/2. Similarly, the regulation member configured of light shielding plates 225, 226, 236 may be configured such that the phase different does not become π/4.

### Second Exemplary Embodiment

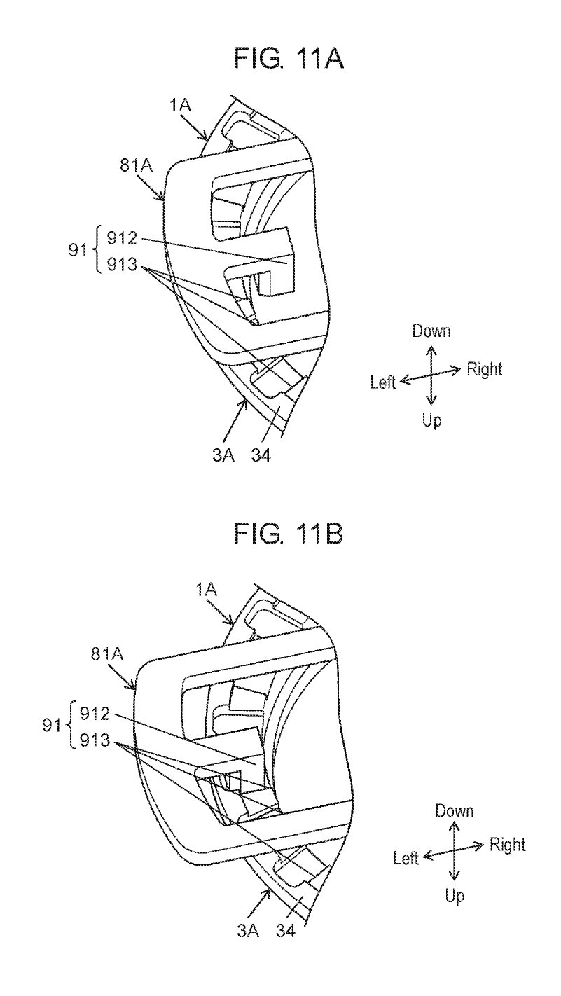

Input device 1A of the present exemplary embodiment differs from input device 1 of the first exemplary embodiment in that input device 1A includes lock mechanism 91 (see FIGS. 11A and 11B). Lock mechanism 91 suppresses transmission of detection information due to movement of operation unit 3A unintentionally operated by a user. Hereinafter, elements similar to those in the first exemplary embodiment are given identical reference signs, and description of such elements is omitted as appropriate. “Operation unit 3A” and “slider 81A” correspond to “operation unit 3” and “slider 81” of the first exemplary embodiment, respectively.

Input device 1A includes lock mechanism 91. Lock mechanism 91 prevents movement of rotation operation unit 301 when input device 1A is in a positioning state.

Lock mechanism 91 includes a movable member that is movable relative to housing 2. Lock mechanism 91 is configured to allow a movable member to move to perform switching between a state in which operation unit 3A is stopped from moving relative to housing 2 and a state in which operation unit 3A is not stopped from moving relative to housing 2. The movable member is slider 81A, for example.

A specific example of lock mechanism 91 will now be described with reference to FIGS. 11A and 11B. FIG. 11A is a perspective view of lock mechanism 91 in a regularly fixed state of input device 1A, seen from below. FIG. 11B is a perspective view of lock mechanism 91 in a positioning state of input device 1A, seen from below. In the examples of FIGS. 11A and 11B, operation unit 3A is a rotation operation unit. As illustrated in FIG. 11A, lock mechanism 91 includes a plurality of first stopping portions 913 provided to operation unit 3A, and second stopping portion 912 provided to a movable member (slider 81A in here). As illustrated in FIG. 11B, lock mechanism 91 is configured to stop operation unit 3A from moving relative to housing 2 when one of the plurality of first stopping portions 913 fits into second stopping portion 912. Respective first stopping portions 913 are provided at predetermined intervals in a moving direction of operation unit 3A (circumferential direction of operation unit 3A).

In the examples of FIGS. 11A and 11B, respective first stopping portions 913 are provided on a lower surface of a flange portion 34 of operation unit 3A at even intervals in a circumferential direction of operation unit 3A. Each of first stopping portions 913 is a recess recessed upward, and is open toward rotation axis Z1. Second stopping portion 912 is provided on a left end of slider 81A serving as a movable member, and is a projection projecting upward from an upper surface of slider 81A. A tip portion (upper end portion) of second stopping portion 912 is inserted in a lower recess 36 (see FIG. 1) of operation unit 3A.

Therefore, when slider 81A lies at a right end position of a movable range (fully fixed state), as illustrated in FIG. 11A, second stopping portion 912 does not fit to either of the plurality of first stopping portions 913, operation unit 3A is thus movable (rotatable) in the circumferential direction. In other words, lock mechanism 91 does not stop operation unit 3A from moving relative to housing 2, and thus a rotation operation can be performed with operation unit 3A.

On the other hand, when slider 81A lies at a left end position of the movable range (positioning state), as illustrated in FIG. 11B, second stopping portion 912 fits to any one of the plurality of first stopping portions 913, and thus operation unit 3A is stopped from moving in the circumferential direction. In other words, lock mechanism 91 stops operation unit 3A from moving relative to housing 2, and thus a rotation operation with operation unit 3A is restricted.

In a temporarily fixed state of input device 1A, lock mechanism 91 may be in a state where operation unit 3A is not stopped from moving relative to housing 2, or in a state where operation unit 3A is stopped from moving relative to housing 2.

With this configuration, as lock mechanism 91 stops operation unit 3A from moving relative to housing 2, operation unit 3 is suppressed from moving by an unintentional operation by a user, in the positioning state. This means that lock mechanism 91 can suppress erroneous transmission of detection information in the positioning state. For example, even when an operator grabs operation unit 3A when attaching input device 1A to display device 100, detection information can be suppressed from being erroneously transmitted as long as lock mechanism 91 stops movement of operation unit 3A. Respective first stopping portions 913 are provided at predetermined intervals in a moving direction of operation unit 3A. Accordingly, lock mechanism 91 can prevent operation unit 3A from moving relative to housing 2, while hardly moving operation unit 3A from an arbitrary position of operation unit 3A when operation of operation unit 3A is completed.

An unevenness relationship between the plurality of first stopping portions 913 and second stopping portion 912 may be reversed from the relationship exemplified in FIG. 11A. In other words, the plurality of first stopping portions 913 may be projections, while second stopping portion 912 may be a recess.

Similar to the present exemplary embodiment, it is preferable that the movable member is slider 81A for changing a holding force applied by attaching portion 8 from input device 1A to display device 100. Thus, lock mechanism 91 can suppress transmission of detection information due to movement of operation unit 3A unintentionally operated by a user, in the positioning state. Moreover, even when an operator unintentionally operates operation unit 3A in a state where input device 1A is removed from display device 100, for example, lock mechanism 91 can suppress erroneous transmission of detection information.

However, the movable member is not necessarily slider 81A in input device 1A. The movable member may be provided independent of slider 81A.

Other configurations and functions are the same as those of the first exemplary embodiment. The configuration described in the second exemplary embodiment is applicable by being appropriately combined with the respective configurations (including modifications) described in the first exemplary embodiment.

### Third Exemplary Embodiment

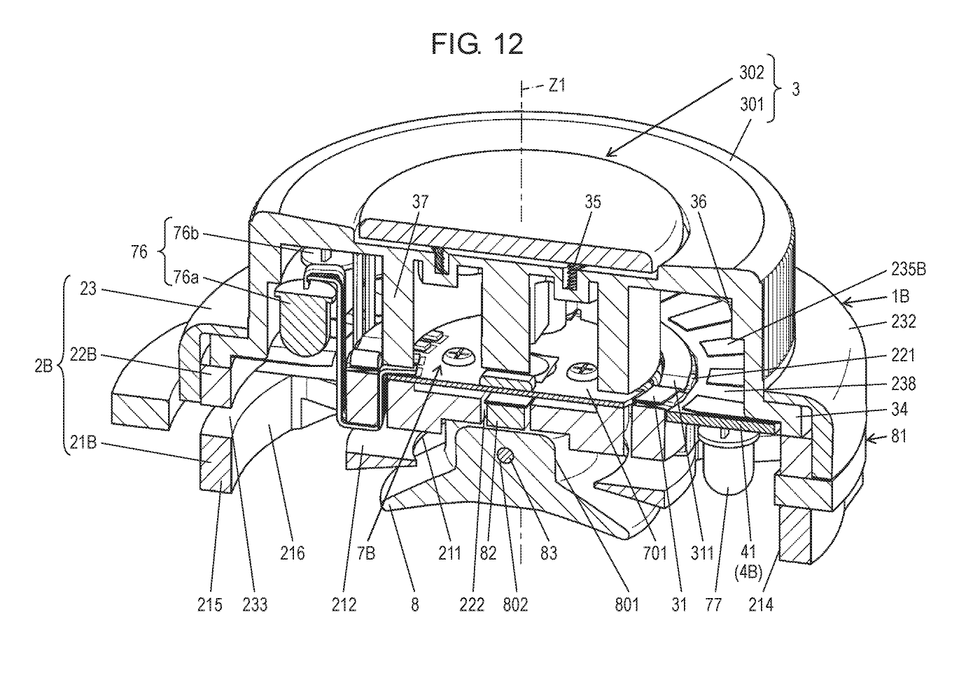

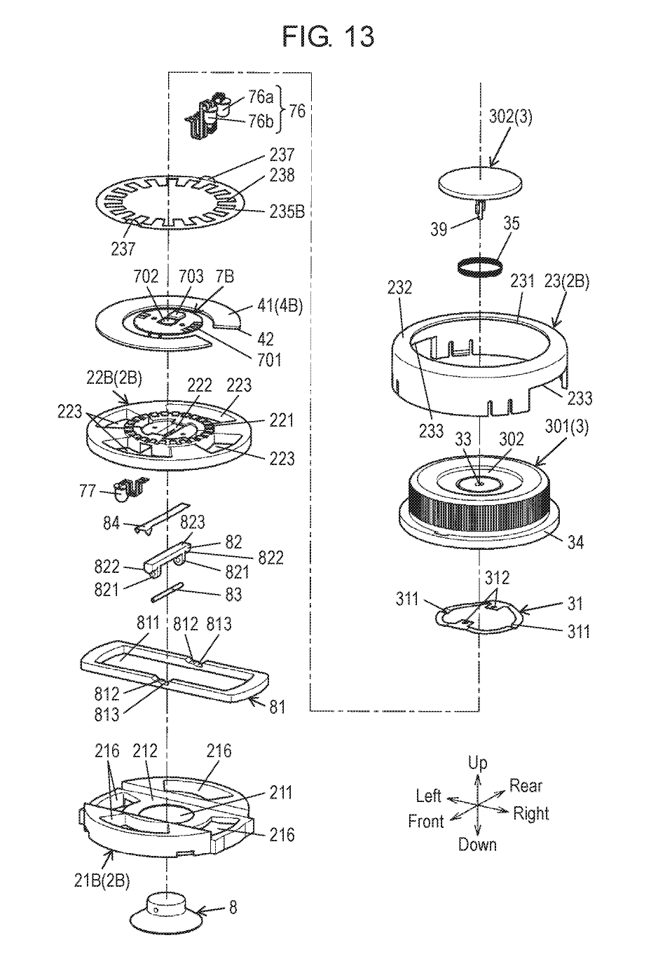

As illustrated in FIGS. 12 and 13, input device 1B of the present exemplary embodiment differs from input device 1 of the first exemplary embodiment in that input device 1B includes light receiving element 76 for detecting operation of rotation operation unit 301, and light detection element 77 for detecting a specific region. Elements similar to those in the first exemplary embodiment are given identical reference signs, and description of such elements is omitted as appropriate. “Housing 2B”, “first case 21B”, “second case 22B”, “photovoltaic unit 4B”, “signal processor 7B”, and “light shielding plate 235B” correspond to “housing 2”, “first case 21”, “second case 22”, “photovoltaic unit 4”, “signal processor 7”, and “light shielding plate 235” in the first exemplary embodiment, respectively.

The shape of first case 21B is a disk shape that is flat in the up-down direction. First case 21B is made of a material having low light transmission property (synthetic resin such as polystyrene or polyethylene, or metal). First case 21B has, in an outer circumferential portion around hole 211, four through holes 216 (transmission parts) each penetrating first case 21B in the up-down direction.

The shape of second case 22B is a disk shape that is flat in the up-down direction. Second case 22B is made of a material having low light transmission property (synthetic resin such as polystyrene or polyethylene, or metal).

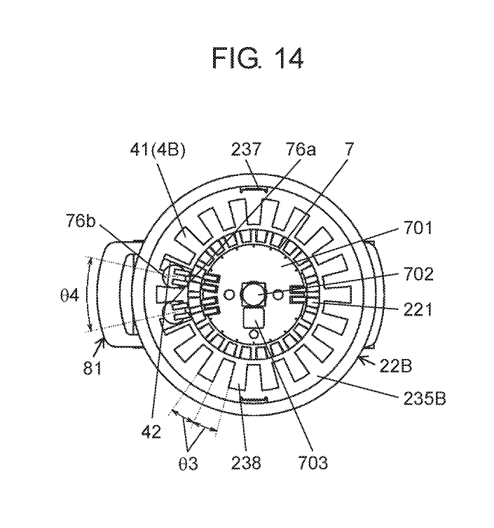

As illustrated in FIGS. 12 and 14, solar battery 41 constituting photovoltaic unit 4B is disposed on an outer circumferential portion of an upper surface of second case 22B. The shape of solar battery 41, in a planer view, is a ring shape lacking a portion (C shape). Solar battery 41 is attached to the upper side of second case 22B such that a light receiving surface faces downward. Second case 22B has, in a portion where solar battery 41 is disposed, four through holes 223 (transmission parts) each penetrating second case 22B in the up-down direction. In a state where second case 22B is attached to the upper side of first case 21B, through holes 223 of second case 22B and through holes 216 of first case 21B overlap in the up-down direction. This means that respective through holes 216, 223 serve as transmission parts that transmit light from the lower side of housing 2 to photovoltaic unit 4B. While through holes 216 and through holes 223 serving as transmission parts are provided in four each, a number of through holes 216, 223 is not limited to four. The number, shape, and size of through holes 216, 223 can be changed as appropriate if they can transmit light sufficient for generating electric power required for operating signal processor 7.

Above second case 22B, light shielding plate 235B (light shielding unit) made of a material having a light shielding property (metal, for example) is disposed to be placed on an upper side of solar battery 41. Light shielding plate 235B has a plurality of slits 238 opening toward rotation axis Z1. Respective slits 238 are provided at certain intervals in a circumferential direction of light shielding plate 235. In the example of FIG. 14, an angle defined by two long sides (two sides parallel to a radial direction) of each slit 238 is θ3, and each slit 238 is provided at every fixed angle (2×θ3) in the circumferential direction. Light shielding plate 235B is attached to a lower surface of flange portion 34 of rotation operation unit 301. As light shielding plate 235B is rotated along with rotation of rotation operation unit 301, light shielding plate 235B is rotated relative to light receiving element 76.

In the center of an upper surface of second case 22, printed board 701 is attached with a screw or the like. Printed board 701 is a circular substrate. On printed board 701, electronic parts constituting signal processor 7B are mounted. A circuit of signal processor 7B is electrically connected with solar battery 41. On printed board 701, light receiving element 76 and light detection element 77 are mounted. Light receiving element 76 includes light receiving element 76a and light receiving element 76b. Light receiving element 76a is an example of a first light receiving element. Light receiving element 76b is an example of a second light receiving element. Each of light receiving element 76a, 76b and light detection element 77 is a photodiode.

Light receiving elements 76a, 76b are disposed above interrupted portion 42 of solar battery 41 above light shielding plate 235B. Light receiving elements 76a, 76b are disposed side by side in a circumferential direction with the light receiving surfaces facing downward. Light receiving elements 76a, 76b are positioned above an inner circumferential portion where slit 238 is provided in light shielding plate 235B. To light receiving elements 76a, 76b, light passing through slit 238 enters. Here, light receiving elements 76a, 76b are disposed while being separated by an angle θ4 from each other in the circumferential direction. The angle θ4 is two and a half times as large as an angle width θ3 of slit 238.

Accordingly, in the case where one of light receiving elements 76a, 76b overlaps any of slits 238 entirely in the up-down direction, the other one of light receiving elements 76a, 76b overlaps only a half of any of slits 238. In that case, the light receiving quantity of the other one of light receiving elements 76a, 76b becomes a half of the light receiving quantity of the maximum case.

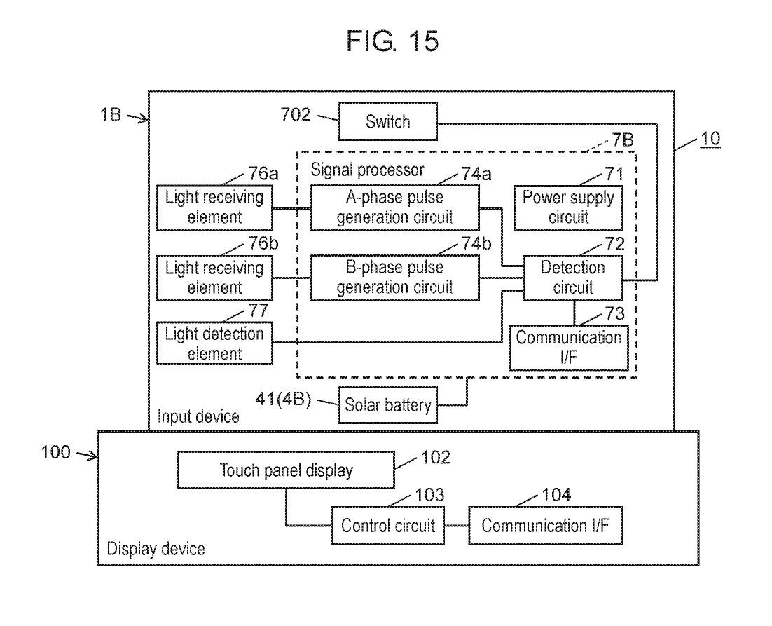

When light shielding plate 235B is rotated along with rotation of rotation operation unit 301, the overlapping state between each of light receiving elements 76a, 76b and slits 238 is changed. Then, a quantity of light made incident on each of light receiving elements 76a, 76b is changed. Accordingly, when rotation operation unit 301 is rotated in one direction at a constant speed, respective waveforms of outputs (output voltage or output current) of light receiving elements 76a, 76b are waveforms having a constant cycle. In the case where slit 238 is in a longitudinal shape as in the present exemplary embodiment, the waveform of each of the outputs is a triangular wave. In more detail, the waveform of an output of light receiving element 76a is a waveform in which a phase is shifted by π/4 relative to the waveform of an output of light receiving element 76b. Then, A-phase pulse generation circuit 74a electrically connected with light receiving element 76a and B-phase pulse generation circuit 74b electrically connected with light receiving element 76b (see FIG. 15) output pulse signals P1, P2, respectively. Pulse signals P1, P2 are pulse signals in which the cycles are the same and the phases are shifted by π/4 from each other. Further, whether pulse signal P2 becomes a leading phase or a lagging phase relative to pulse signal P1 is switched according to an operating direction of rotation operation unit 301. This means that light shielding plate 235B is formed to change a quantity of light made incident on photovoltaic unit 4 differently, depending on the case where rotation operation unit 301 is rotated in one direction and the case where rotation operation unit 301 is rotated in an opposite direction. In other words, light shielding plate 235B gives a different phase to the quantity of light made incident on light receiving element 76a and to the quantity of light made incident on light receiving element 76b, when rotation operation unit 301 is rotated.

Accordingly, detection circuit 72 of signal processor 7B can detect the rotation quantity and the rotation direction of rotation operation unit 301, based on pulse signals P1, P2 input from A-phase pulse generation circuit 74a and B-phase pulse generation circuit 74b, respectively. Signal processor 7B transmits detection information generated according to an operation of rotation operation unit 301 based on a detection result of detection circuit 72, from communication I/F 73 via wireless communication.

On the other hand, light detection element 77 is disposed in through hole 216 of first case 21 below solar battery 41, with the light receiving surface facing downward. Accordingly, on light detection element 77, light is made incident from below housing 2 via through hole 216. Thus, in a state where input device 1B is attached to attaching surface 101 (display surface) of display device 100, light emitted from the display surface can be made incident on light detection element 77. This means that light detection element 77 is disposed at a position where light detection element 77 can receive light made incident from a side where attaching portion 8 is disposed in housing 2.

Light detection element 77 is used to detect a specific region. When a predetermined change occurs in an output of light detection element 77 in a state where a specific region is displayed on the display surface of display device 100, signal processor 7B determines that the attaching position of input device 1B overlaps the specific region. Optical energy emitted from the specific region is smaller than optical energy emitted from a region other than the specific region on the display surface, for example. When a drop range of an output of light detection element 77 exceeds a prescribed value, signal processor 7B determines that the attaching position of input device 1B overlaps the specific region. Then, when signal processor 7B determines that the attaching position of input device 1B overlaps the specific region, signal processor 7B transmits notification information from communication I/F 73 to display device 100 via wireless communication. Thus, display device 100 can estimate the position of input device 1B from the position of the specific region at the time of receiving the notification information.

Input device 1B of the present exemplary embodiment described above further includes light receiving element 76 and light shielding plate 235B. Light receiving element 76 is disposed at a position where light receiving element 76 can receive light made incident from a side where attaching portion 8 is disposed in housing 2. Light shielding plate 235B changes a quantity of light made incident on light receiving element 76 in conjunction with movement of rotation operation unit 301.

Thus, signal processor 7B can detect movement of rotation operation unit 301 based on a change in an output of light receiving element 76, and transmit detection information generated in response to a detection result of the movement of rotation operation unit 301 via wireless communication.

In input device 1B of the present exemplary embodiment, rotation operation unit 301 is disposed rotatably in either direction relative to housing 2. Light shielding plate 235B is formed to change the quantity of light made incident on light receiving element 76 differently, depending on the case where rotation operation unit 301 is rotated in one direction and the case where rotation operation unit 301 is rotated in an opposite direction.

Thus, signal processor 7 can detect rotational movement in either direction of rotation operation unit 301 based on a change in an output of light receiving element 76. Therefore, signal processor 7 can transmit detection information generated according to a detection result of the rotational movement in either direction of rotation operation unit 301, via wireless communication.

In input device 1 of the present exemplary embodiment, rotation operation unit 301 is disposed rotatably in either direction relative to housing 2. Light receiving element 76 includes light receiving element 76a and light receiving element 76b. Light shielding plate 235B gives a different phase to a quantity of light made incident on light receiving element 76a and to a quantity of light made incident on light receiving element 76b, when rotation operation unit 301 is rotated.

Thus, signal processor 7 can detect rotational movement in either direction of rotation operation unit 301 based on a phase difference between an output of light receiving element 76a and an output of light receiving element 76b. Therefore, signal processor 7 can transmit detection information generated according to a detection result of the rotational movement in either direction of rotation operation unit 301, via wireless communication.

In input device 1B of the present exemplary embodiment, signal processor 7 transmits notification information via wireless communication when a predetermined change occurs in an output of light detection element 77. When control circuit 103 of display device 100 receives the notification information in a state where a specific region is displayed on the display surface, control circuit 103 estimates the attaching position of input device 1B on the display surface from the position of the specific region at the time of receiving the notification information.

As described above, input device 1B can detect the specific region with use of light detection element 77. Accordingly, display device 100 is able to estimate the attaching position of input device 1B on the basis of the notification information received from input device 1B.

In input device 1B, light detection element 77 may be replaced with light receiving element 76a, 76b if either of light receiving elements 76a, 76b can regularly receive light from display device 100.

While the configuration of light receiving element 76 includes light receiving element 76a and light receiving element 76b, a configuration including only one light receiving element is also adoptable. In such a configuration, each slit 238 of light shielding plate 235B is in a triangular shape asymmetric to a radial direction, for example. With this configuration, light shielding plate 235B can change the quantity of light made incident on light receiving element 76 configured of only one light receiving element differently, depending on the case where rotation operation unit 301 is rotated in one direction and the case where rotation operation unit 301 is rotated in an opposite direction. Thus, signal processor 7 can detect rotational movement in either direction of rotation operation unit 301 with only one light receiving element.

As a modification of the third exemplary embodiment, input device 1B may include only one light receiving element electrically connected with A-phase pulse generation circuit 74a, and solar battery 41 may be electrically connected with B-phase pulse generation circuit 74b. In that case, light shielding plate 235B is disposed below solar battery 41. Light shielding plate 235B gives a different phase to the quantity of light made incident on the light receiving element and to the quantity of light made incident on solar battery 41, when rotation operation unit 301 is rotated.

With the configuration of the modification described above, detection circuit 72 of signal processor 7B can detect the rotation quantity and the rotation direction of rotation operation unit 301, based on pulse signals P1, P2 input from A-phase pulse generation circuit 74a and B-phase pulse generation circuit 74b, respectively. Thus, it is possible to reduce the number of components of input device 1B of the modification.

Other configurations and functions are the same as those of the first exemplary embodiment. The configuration described in the third exemplary embodiment is applicable by being appropriately combined with the respective configurations (including modifications) described in the first and second exemplary embodiments.

### Other Exemplary Embodiments

As described above, the first to third exemplary embodiments have been described as examples of the technology disclosed in the present application. However, the technology of the present disclosure is not limited to them, and is also applicable to exemplary embodiments in which changes, replacements, additions, omissions, and the like are made. It is also possible to realize a new exemplary embodiment by combining respective constituent elements described in the first to third exemplary embodiments.

Accordingly, other exemplary embodiments will be described below.

Display device 100 according to another exemplary embodiment includes touch panel display 102, communication I/F 104, and control circuit 103. Touch panel display 102 has attaching surface 101 to which input device 1 is attached. Communication I/F 104 receives a signal transmitted from input device 1 via wireless communication. Control circuit 103 controls display content to be displayed on touch panel display 102. Then, in a reception waiting state where control circuit 103 waits to receive information transmitted from input device 1 via wireless communication, control circuit 103 allows the attaching position of input device 1 on attaching surface 101 to emit light. Control circuit 103 also allows display contents related to operation using input device 1 to be displayed on touch panel display 102 in a region other than the attaching position of input device 1.

Thus, it is possible to perform operation with use of input device 1 attached to attaching surface 101, without an electric wire or the like connecting display device 100 with input device 1.

In display device 100 according to another exemplary embodiment, control circuit 103 allows a specific region in which the position of the specific region moves as time passes to be displayed on touch panel display 102. Optical energy emitted from the specific region differs from optical energy emitted from a region other than the specific region on attaching surface 101. When control circuit 103 receives notification information, notifying that the specific region is detected, from input device 1 in a state where the specific region is displayed on touch panel display 102, control circuit 103 estimates the attaching position of input device 1 on the attaching surface 101, from the specific region at the time when the control circuit receives the notification information.

Thus, display device 100 can estimate the attaching position of input device 1, without having a sensor or the like for measuring the attaching position of input device 1.

A data input method according to another exemplary embodiment is an information input method of inputting information to display device 100 with use of input device 1 attached to attaching surface 101 of display device 100. The data input method includes a step of performing photovoltaics with use of light emitted from attaching surface 101 to input device 1, a step of detecting operation content performed by using input device 1, and a step of transmitting detection information in response to the operation content via wireless communication with use of electric power generated by photovoltaics.

Thus, input device 1 can acquire electric power required for operation by generating power with light emitted from attaching surface 101 to input device 1. Then, input device 1 transmits detection information in response to the operation content via wireless communication. Accordingly, display device 100 can detect an operation using input device 1 without using a touch panel display 102.

A data input method according to another exemplary embodiment further includes, in addition to the data input method described above, a step of emitting light at the attaching position of input device 1 on attaching surface 101, and a step of receiving detection information transmitted from input device 1 via wireless communication.

As described above, since display device 100 emits light at the attaching position of input device 1 on attaching surface 101, input device 1 can acquire electric power required for operation by photovoltaics.

A data input method according to another exemplary embodiment further includes, in addition to any of the data input methods described above, a step of allowing entire attaching surface 101 to emit light in a search process of searching for an attaching position of input device 1 on attaching surface 101. The data input method further includes a step of, after allowing the entire attaching surface 101 to emit light, displaying, on touch panel display 102, a specific region in which the position of the specific region moves as time passes.

As described above, since display device 100 allows the entire attaching surface 101 to emit light, it is possible to acquire electric power required for operation by performing photovoltaics by input device 1. Then, since display device 100 displays the specific region on attaching surface 101, input device 1 can detect the attaching position from a change in optical energy made incident.

A data input method according to another exemplary embodiment includes, in addition to any of the data input methods described above, a step of transmitting notification information by input device 1 via wireless communication, when a predetermined change occurs in a quantity of electric power generated by light emitted from attaching surface 101 to input device 1 in a state where the specific region is displayed on attaching surface 101, in a search process. The data input method further includes a step of estimating an attaching position of input device 1 on attaching surface 101 from a position of the specific region at a time when display device 100 receives the notification information.

As described above, input device 1 transmits notification information via wireless communication when a predetermined change occurs in the quantity of generated power. Accordingly, input device 1 can also use photovoltaic unit 4, provided for photovoltaics, for searching for an attaching position.

A data input method according to another exemplary embodiment includes, in addition to any of the data input methods described above, a step of displaying display content related to an operation of input device 1 around an attaching position of input device 1 on attaching surface 101, in response to a detection result of the attaching position of input device 1.

Thus, display device 100 can display display content related to an operation at an easily visible position, according to the attaching position of input device 1.

A data input method according to another exemplary embodiment includes, in addition to any of the data input methods described above, a step of allowing an attaching position of input device 1 on attaching surface 101 to emit light, in response to a result of searching for the attaching position of input device 1 on attaching surface 101.

Thus, input device 1 can acquire electric power required for operation by performing photovoltaics.

A data input method according to another exemplary embodiment includes, in addition to any of the data input methods described above, a step of allowing an attaching position of input device 1 on attaching surface 101 to emit light, and displaying display content related to an operation of input device 1 around the attaching position of input device 1 on attaching surface 101, in response to a result of detecting the attaching position of input device 1 on attaching surface 101. The data input method further includes a step of controlling the display content of attaching surface 101 in response to the detection information, when receiving detection information transmitted from input device 1 via wireless communication.

Thus, input device 1 can acquire electric power required for operation by performing photovoltaics. Display device 100 can also display display content related to an operation at an easily visible position, according to the attaching position of input device 1.

A data input method according to another exemplary embodiment is a data input method of display device 100 in which detection information corresponding to an operation is transmitted from input device 1 attached to attaching surface 101 via wireless communication. The data input method includes a step of allowing an attaching position of input device 1 on attaching surface 101 to emit light, and displaying display content related to input operation using input device 1 at a portion other than the attaching position of input device 1 on attaching surface 101, in a reception waiting state of waiting for receiving information transmitted from input device 1 via wireless communication. The data input method further includes a step of receiving detection information transmitted from input device 1 by a wireless signal, and detecting operation content performed by using input device 1.

As described above, as display device 100 allows the attaching position of input device 1 on attaching surface 101 to emit light, input device 1 can perform photovoltaics. Further, since display device 100 displays display content in a portion other than the attaching position of input device 1 on attaching surface 101, the display content is displayed at an easily visible position. Furthermore, it is possible to perform operation using input device 1 attached to attaching surface 101, without an electric wire or the like connecting display device 100 with input device 1.

A data input method according to another exemplary embodiment includes, in addition to any of the data input methods described above, a step of allowing the entire attaching surface 101 to emit light before displaying a specific region on attaching surface 101.

As described above, display device 100 allows the entire attaching surface 101 to emit light in a state where an attaching position of input device 1 is not specified. Therefore, input device 1 can acquire electric power required for operation by performing photovoltaics.

A data input method according to another exemplary embodiment includes, in addition to any of data input methods described above, a step of, when receiving notification information indicating that input device 1 detects a specific region from input device 1 via wireless communication in a state where the specific region is displayed on attaching surface 101, estimating an attaching position of input device 1 on attaching surface 101 from a position of the specific region at the time of receiving the notification information.

Thus, display device 100 can estimate the attaching position of input device 1 from the position of the specific region at the time of receiving the notification information from input device 1.

A data input method according to another exemplary embodiment includes, in addition to any of the data input methods described above, displaying display content according to an operation content detected based on detection information, on touch panel display 102.

Thus, display device 100 can display display content in response to operation content at a position not interrupted by input device 1, according to the attaching position of input display 1.

A program according to another exemplary embodiment is a program for causing display device 100 to perform any of the data input methods described above.

### REFERENCE MARKS IN THE DRAWINGS

1, 1A, 1B: input device
2, 2B: housing
3, 3A: operation unit
4, 4B: photovoltaic unit
4a: A-phase solar battery (first photovoltaic unit)
4b: B-phase solar battery (second photovoltaic unit)
7, 7B: signal processor
8: attaching portion
10: input system
41: solar battery
72: detection circuit
76: light receiving element
76a: light receiving element (first light receiving element)
76b: light receiving element (second light receiving element)
77: light detection element
81, 81A: slider
100: display device
101: attaching surface (display surface, attaching target portion)
102: touch panel display (display unit)
103: control circuit
104: communication unit (communication I/F)
215: surrounding wall (contact portion)
225, 226, 235: light shielding plate (regulation member)
235B: light shielding plate (light shielding unit)
301: rotation operation unit
302: push operation unit (notification operation unit)
V1, V2: specific region
M1: display content

1. An input device comprising:
a housing;
an operation unit movable relative to the housing;
an attaching portion used for attaching the housing;
a photovoltaic unit held by the housing, the photovoltaic unit generating electric power with use of light incident from a side in which the attaching portion is disposed in the housing; and
a signal processor that operates by receiving the electric power generated by the photovoltaic unit, and transmits detection information generated in response to movement of the operation unit via wireless communication.

2. The input device according to claim 1, wherein the attaching portion is a sucker.

3. The input device according to claim 1, wherein the housing includes a transmission part that transmits the light incident from the side in which the attaching portion is disposed in the housing.

4. The input device according to claim 1, wherein when a predetermined change occurs in the electric power generated by the photovoltaic unit, the signal processor transmits notification information via wireless communication.

5. The input device according to claim 1, further comprising a regulation member that changes a quantity of light incident on the photovoltaic unit in conjunction with the movement of the operation unit,
wherein the signal processor detects the movement of the operation unit based on a change in the electric power generated by the photovoltaic unit, and transmits detection information generated in response to a result of detecting the movement of the operation unit via wireless communication.

6. The input device according to claim 5, wherein
the operation unit is disposed rotatably in either direction relative to the housing, and
the regulation member is formed to change the quantity of light incident on the photovoltaic unit differently, depending on a case in which the operation unit is rotated in one direction and a case in which the operation unit is rotated in an opposite direction.

7. The input device according to claim 5, wherein
the operation unit is disposed rotatably in either direction relative to the housing,
the photovoltaic unit includes a first photovoltaic unit and a second photovoltaic unit, and
the regulation member gives a different phase to a quantity of light incident on the first photovoltaic unit and to a quantity of light incident on the second photovoltaic unit, when the operation unit is rotated.

8. The input device according to claim 1, further comprising:
a light receiving element; and
a light shielding unit,
wherein
the light receiving element is disposed at a position at which the light receiving element receives light incident from the side in which the attaching portion is disposed in the housing,
the light shielding unit changes a quantity of the light incident on the light receiving element in conjunction with the movement of the operation unit, and
the signal processor detects the movement of the operation unit based on a change in an output of the light receiving element, and transmits detection information generated in response to a result of detecting the movement of the operation unit via wireless communication.

9. The input device according to claim 8, wherein
the operation unit is disposed rotatably in either direction relative to the housing, and
the light shielding unit is formed to change the quantity of light incident on the light receiving element differently, depending on a case in which the operation unit is rotated in one direction and a case in which the operation unit is rotated in an opposite direction.

10. The input device according to claim 8, wherein
the operation unit is disposed rotatably in either direction relative to the housing,
the light receiving element includes a first light receiving element and a second light receiving element, and
the light shielding unit gives a different phase to a quantity of light incident on the first light receiving element and to a quantity of light incident on the second light receiving element, when the operation unit is rotated.

11. The input device according to claim 1, wherein the housing includes a contact portion to be brought into contact with the attaching target portion in a state where the housing is attached to an attaching target portion via the attaching portion.

12. An input system comprising:
the input device according to claim 1; and
a display device,
wherein the display device includes:
a display unit having a display surface to which the attaching portion is attached; and
a control circuit that controls display content to be displayed on the display unit, and allows the display content to be displayed on the display unit.

13. The input system according to claim 12, wherein in a reception waiting state in which reception of information transmitted from the input device via wireless communication is waited, the control circuit controls the display content so as to allow the attaching position of the input device on the display surface to emit light.

14. The input system according to claim 12, wherein
the operation unit includes a notification operation unit to be operated for notifying that the input device is in an attached state in which the input device is attached to the display surface, and
the signal processor transmits, via wireless communication, start-up information for notifying the attached state when the notification operation unit is operated.

15. The input system according to claim 12, wherein
the control circuit allows a specific region to be displayed on the display unit, a position of the specific region moving as time passes,
optical energy emitted from the specific region differs from optical energy emitted from a region other than the specific region on the display surface,
the signal processor transmits notification information via wireless communication when a predetermined change occurs in electric power generated by the photovoltaic unit, and
when the control circuit receives the notification information in a state where the specific region is displayed on the display unit, the control circuit estimates an attaching position of the input device on the display surface from a position of the specific region at a time when the control circuit receives the notification information.

16. The input system according to claim 12, wherein
the input device further includes a light detection element disposed at a position at which the light detection element receives light incident from a side in which the attaching portion is disposed in the housing,
the control circuit allows a specific region to be displayed on the display unit, a position of the specific region moving as time passes,
optical energy emitted from the specific region differs from optical energy emitted from a region other than the specific region on the display surface,
the signal processor transmits notification information via wireless communication when a predetermined change occurs in an output of the light detection element, and
when the control circuit receives the notification information in a state in which the specific region is displayed on the display unit, the control circuit estimates an attaching position of the input device on the display surface from a position of the specific region at a time when the control circuit receives the notification information.

17. The input system according to claim 15, wherein the specific region is in a band shape, and moves along a first direction on the display surface and a second direction on the display surface, the second direction crossing the first direction.

18. The input system according to claim 15, wherein optical energy emitted from the specific region is smaller than optical energy emitted from a region other than the specific region on the display surface.

19. The input system according to claim 15, wherein the control circuit controls the display content such that optical energy emitted from the attaching position of the input device on the display surface becomes predetermined optical energy, according to a result of estimating the attaching position of the input device on the display surface.

20. The input system according to claim 15, wherein the control circuit controls a position of the display content to be displayed around the attaching position of the input device on the display surface, according to a result of estimating the attaching position of the input device on the display surface.
